(19) United States
(12) Patent Application Publication
(10) Pub. No.: US 2021/0053459 A1
(43) Pub. Date: Feb. 25, 2021

(54) ELECTRIC POWER SYSTEM AND VEHICLE

(71) Applicant: Toyota Jidosha Kabushiki Kaisha, Toyota-shi Aichi-ken (JP)

(72) Inventors: Yoshiyuki Tsuchiya, Hamamatsu-shi (JP); Toru Nakamura, Toyota-shi (JP); Shigeki Kinomura, Toyota-shi (JP); Hidetoshi Kusumi, Nagoya-shi (JP); Hironobu Kitaoka, Nisshin-shi (JP)

(21) Appl. No.: 16/998,227

(22) Filed: Aug. 20, 2020

(30) Foreign Application Priority Data
Aug. 22, 2019 (JP) 2019-152102

(51) Int. Cl. B60L 53/67; B60L 53/53; B60L 53/30

(52) U.S. Cl. CPC B60L 53/67; B60L 2240/72; B60L 53/30; B60L 53/53

(57) ABSTRACT

An electric power system includes a first vehicle, a second vehicle, and an external power supply. The first vehicle starts external charging of a first power storage with electric power supplied from the external power supply while the first vehicle is electrically connected to the external power supply. When the second vehicle receives a signal that predicts end of external charging of the first power storage while the second vehicle is electrically connected to the external power supply, the second vehicle starts external charging of a second power storage with electric power supplied from the external power supply before end of external charging started in the first vehicle.

### CROSS REFERENCE TO RELATED APPLICATION

This nonprovisional application claims priority to Japanese Patent Application No. 2019-152102 filed with the Japan Patent Office on Aug. 22, 2019, the entire contents of which are hereby incorporated by reference.

### BACKGROUND

### Field

The present disclosure relates to an electric power system and a vehicle, and particularly to a technique with which a plurality of vehicles included in an electric power system successively carry out external charging.

### Description of the Background Art

Japanese Patent Laying-Open No. 2017-139961 discloses a charging management method of preparing a charging plan that shows a schedule of external charging (for example, time to start external charging and time to quit external charging) at each charging facility installed at a plurality of locations and notifying a plurality of electric vehicles of the prepared charging plan. “External charging” refers to charging of a power storage mounted on a vehicle with electric power supplied from the outside of the vehicle.

### SUMMARY

By notifying each of a plurality of electric vehicles of a charging plan as above, a schedule of external charging to be carried out in each electric vehicle can be controlled. In each electric vehicle notified of the charging plan, however, external charging is not necessarily carried out as planned. When a plurality of vehicles carry out external charging successively in a relayed manner by receiving supply of electric power from a common external power supply with the method described in Japanese Patent Laying-Open No. 2017-139961, even though the charging plan has assumed continuous external charging in a plurality of vehicles, charging discontinuity (that is, a period for which none of vehicles carries out external charging) may be created between end of external charging in a preceding vehicle and start of external charging in a next vehicle.

The present disclosure was made to solve the problems above, and an object thereof is to allow continuous external charging in a plurality of vehicles when the plurality of vehicles carry out external charging successively in a relayed manner by receiving supply of electric power from a common external power supply.

An electric power system according to a first point of view of the present disclosure includes a first vehicle including an externally chargeable first power storage, a second vehicle including an externally chargeable second power storage, and an external power supply that supplies electric power to each of the first vehicle and the second vehicle. The first vehicle starts external charging of the first power storage with electric power supplied from the external power supply while the first vehicle is electrically connected to the external power supply. When the second vehicle receives a signal predicting end of external charging of the first power storage while the second vehicle is electrically connected to the external power supply, the second vehicle starts external charging of the second power storage with electric power supplied from the external power supply before end of external charging started in the first vehicle.

In the electric power system, the first vehicle and the second vehicle carry out external charging successively in the relayed manner by receiving supply of electric power from the common external power supply. The first vehicle starts external charging earlier than the second vehicle. The first vehicle may transmit a signal predicting end of external charging before it quits external charging. The first vehicle can determine whether or not end of external charging is close, for example, while it checks in real time, change in condition (for example, change in state of the first power storage) during external charging. The signal predicting end of external charging of the first power storage is also referred to as a “prediction signal” below. The second vehicle can recognize by receiving the prediction signal that end of external charging in the first vehicle is close (that is, external charging in the first vehicle will soon end). Then, the second vehicle can start external charging of the second power storage before end of external charging in the first vehicle (that is, during external charging in the first vehicle). In such an electric power system, a part just before end of a charging period of the first vehicle overlaps with a part immediately after start of a charging period of the second vehicle. Therefore, no charging discontinuity occurs at the time of succession from the first vehicle to the second vehicle and external charging in the first vehicle and the second vehicle is continuously carried out.

The prediction signal includes both of a prediction signal based on predetermined charging end time and a signal issued in response to sensing of change in state (for example, change in charging power). A server (for example, a server that manages the first vehicle and the second vehicle) may predict charging end timing based on information obtained from the first vehicle (for example, information representing a state of the first vehicle). The prediction signal may be transmitted from the server to the second vehicle. The prediction signal may be transmitted directly from the first vehicle to the second vehicle. The prediction signal may be transmitted from the first vehicle to the server, where prescribed conversion processing is performed on the signal, and then transmitted to the second vehicle.

The electric power system may further include an electric power controller that controls at least one of the first vehicle and the second vehicle so as to keep a sum of charging power for the first power storage and charging power for the second power storage (which is also referred to as “total sum electric power” below) at determined electric power during a period for which both of external charging of the first power storage in the first vehicle and external charging of the second power storage in the second vehicle are simultaneously carried out (which is also referred to as an “overlapping charging period” below).

In the electric power system, as the electric power controller keeps total sum electric power at determined electric power, an amount of power demand for the external power supply can be stabilized. According to the configuration, both of excessively high power demand for the external power supply and excessively low power demand for the external power supply can be suppressed. The electric power controller may be mounted on one or both of the first vehicle and the second vehicle, or on the outside of the first vehicle and the second vehicle (for example, a server which will be described later).

The electric power system may further include a first charging controller that carries out external charging of the first power storage in a prescribed first charging pattern. The prescribed first charging pattern may include a first charging period and a second charging period following the first charging period. The first charging period may be a period during which external charging with first electric power is carried out. The second charging period may be a period during which external charging with electric power lower than the first electric power is carried out. The second vehicle may receive a signal predicting end of external charging of the first power storage at the end of the first charging period or during the second charging period. The first charging controller may be mounted on the first vehicle or on the outside of the first vehicle (for example, a server which will be described later).

In the electric power system, external charging is started in response to reception by the second vehicle of the prediction signal at the end of the first charging period or during the second charging period, and therefore the second charging period can be set as the overlapping charging period. During the overlapping charging period, the external power supply that supplies electric power to each of the first vehicle and the second vehicle tends to be excessively high in power demand. In this regard, according to the electric power system, during the second charging period, the first power storage is externally charged with electric power lower than first electric power. According to such a configuration, excessively high power demand for the external power supply can be suppressed. During the first charging period, on the other hand, the first power storage is externally charged with first electric power. By setting first electric power to electric power suitable for charging of the first power storage, efficiency in charging of the first power storage for the first charging period can be improved.

The electric power system may further include a first charging controller that carries out external charging of the first power storage in a prescribed first charging pattern. The prescribed first charging pattern may include a first charging period and a second charging period following the first charging period. The first charging period may be a period during which external charging with first electric power is carried out. The second charging period may be a period during which external charging with electric power lower than the first electric power is carried out. The second vehicle may receive a signal predicting end of external charging of the first power storage at the end of the first charging period. The electric power system may further include an electric power controller that controls at least one of the first vehicle and the second vehicle so as to keep total sum electric power (that is, the sum of charging power for the first power storage and charging power for the second power storage) at the first electric power during the overlapping charging period (that is, the overlapping charging period for which both of external charging of the first power storage in the first vehicle and external charging of the second power storage in the second vehicle are simultaneously carried out).

In the electric power system, external charging is started in response to reception by the second vehicle of the prediction signal at the end of the first charging period. Therefore, the overlapping charging period can be started substantially simultaneously with the end of the first charging period. In the electric power system, during the first charging period for which only the first vehicle carries out external charging, the first vehicle carries out external charging with first electric power, and during the overlapping charging period for which both of the first vehicle and the second vehicle carry out external charging, the electric power controller keeps total sum electric power at first electric power. Therefore, total sum electric power can be set to first electric power over the first charging period and the overlapping charging period.

As external charging of the first power storage proceeds, a state of charge (SOC) of the first power storage becomes higher. The first charging controller may determine timing of transition from the first charging period to the second charging period based on the SOC of the first power storage.

When an SOC of the first power storage becomes equal to or larger than a prescribed SOC value while external charging of the first power storage is being carried out in the prescribed first charging pattern, the first charging controller may quit the first charging period and make transition to the second charging period. According to such a configuration, until the SOC of the first power storage becomes equal to or larger than a prescribed SOC value, the first power storage can externally be charged with high electric power (that is, first electric power). The SOC represents a remaining amount of stored power, and it is expressed, for example, as a ratio of a current amount of stored power to an amount of stored power in a fully charged state that ranges from 0 to 100%.

The first charging controller may accept input of an SOC value by a user and set the prescribed SOC value based on the SOC value input by the user. According to such a configuration, a user can determine timing of transition from the first charging period to the second charging period.

The first charging controller may set the prescribed SOC value based on an amount of electric power estimated to be used in next travel.

The first charging controller can make transition from the first charging period to the second charging period at timing when an amount of electric power to be used in next travel has been secured in the first power storage. The first charging controller itself may make such estimation or may receive an amount of electric power estimated by another apparatus.

The electric power system may further include a second charging controller that carries out external charging of the second power storage in a prescribed second charging pattern. The prescribed second charging pattern may include a third charging period immediately after start of charging and a fourth charging period following the third charging period. The fourth charging period may be a period during which external charging with second electric power is carried out. The third charging period may be a period during which external charging with electric power lower than the second electric power is carried out. The second charging controller may be mounted on the second vehicle or may be provided outside the second vehicle (for example, a server which will be described later).

In the electric power system, the second vehicle starts external charging in the second charging pattern while the first vehicle is carrying out external charging. A period immediately after start of charging corresponds to the third charging period in the second charging pattern. Therefore, the third charging period can be set as the overlapping charging period. During the overlapping charging period, the external power supply that supplies electric power to each of the first vehicle and the second vehicle tends to be excessively high in power demand. In this regard, in the electric power system, the second power storage is externally charged with electric power lower than second electric power during the third charging period. According to such a configuration, excessively high power demand for the external power supply can be suppressed. During the fourth charging period, the second power storage is externally charged with second electric power. By setting second electric power to electric power suitable for charging of the second power storage, efficiency in charging of the second power storage during the fourth charging period can be improved.

The electric power system may further include a server that issues to the first vehicle, a request for increase in demand for electric power supplied by the external power supply. The first vehicle may start external charging of the first power storage with electric power supplied from the external power supply in response to the request from the server. The external power supply may be a power grid provided by an electric utility. The power grid may supply electric power to a plurality of charging facilities. Each of the first vehicle and the second vehicle may electrically be connected to the power grid through any of the plurality of charging facilities.

According to the configuration, balance between supply and demand of electric power in the power grid can be adjusted through external charging in the first vehicle and the second vehicle.

A vehicle according to a second point of view of the present disclosure can be adapted to a charging method in which a plurality of vehicles carry out external charging successively in a relayed manner by receiving supply of electric power from a common external power supply. The vehicle includes an externally chargeable power storage, a charging controller that controls external charging of the power storage, and a communication controller that controls communication with the outside of the vehicle. The vehicle configured as above is defined as a target vehicle. Another vehicle that is carrying out external charging with the charging method is defined as a preceding vehicle. When the charging controller receives a start signal that predicts end of external charging in the preceding vehicle while the target vehicle is electrically connected to the common external power supply, the charging controller starts external charging of the power storage with electric power supplied from the common external power supply before end of external charging in the preceding vehicle.

The target vehicle can recognize by receiving a start signal, timing of end of external charging in the preceding vehicle that carries out external charging earlier. Therefore, the target vehicle can start external charging before end of external charging in the preceding vehicle (that is, during external charging in the preceding vehicle). The communication controller may transmit an end prediction signal that predicts end of external charging started by the charging controller to the outside of the target vehicle before end of external charging started by the charging controller. With the end prediction signal transmitted from the target vehicle, another vehicle that will carry out external charging next (which is also referred to as a “next vehicle” below) can be informed of timing of end of external charging in the target vehicle (more specifically, end of external charging in the target vehicle being close). The next vehicle can thus start external charging before end of external charging in the target vehicle (that is, during external charging in the target vehicle). With the above-described configuration of each of a plurality of vehicles, external charging in the plurality of vehicles can continuously be carried out when they carry out external charging successively in the relayed manner by receiving supply of electric power from the common external power supply.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing a configuration of a vehicle according to an embodiment of the present disclosure.

FIG. 2 is a diagram showing a schematic configuration of an electric power system according to the embodiment of the present disclosure.

FIG. 3 is a diagram showing an external power supply, a plurality of charging facilities, and a plurality of vehicles included in the electric power system according to the embodiment of the present disclosure.

FIG. 4 is a diagram for illustrating relayed charging carried out by the plurality of vehicles included in the electric power system according to the embodiment of the present disclosure.

FIG. 5 is a diagram showing a first charging pattern adopted in the electric power system according to the embodiment of the present disclosure.

FIG. 6 is a diagram showing a second charging pattern adopted in the electric power system according to the embodiment of the present disclosure.

FIG. 7 is a timing chart for illustrating a CP1 period, a CV period, and a CP2 period.

FIG. 8 is a flowchart showing charging control carried out by a controller of each vehicle included in the electric power system according to the embodiment of the present disclosure.

FIG. 9 is a flowchart showing processing involved with setting of a threshold value in a user input mode.

FIG. 10 is a flowchart showing processing involved with setting of a threshold value in an automatic setting mode.

FIG. 11 is a flowchart showing processing performed by a controller of a server when an aggregator trades electric power in a power market.

FIG. 12 is a flowchart showing processing involved with relayed charging performed by the controller of the server in the electric power system according to the embodiment of the present disclosure.

FIG. 13 is a flowchart showing processing involved with relayed charging performed by the controller of each vehicle included in the electric power system according to the embodiment of the present disclosure.

FIG. 14 is a diagram showing exemplary relayed charging carried out by a plurality of charging groups simultaneously in parallel.

FIG. 15 is a diagram showing exemplary external charging in the first charging pattern in each vehicle belonging to a charging group.

FIG. 16 is a diagram showing a first modification of the first charging pattern.

FIG. 17 is a diagram showing a second modification of the first charging pattern.

FIG. 18 is a diagram showing a third modification of the first charging pattern.

FIG. 19 is a diagram showing a modification of the electric power system shown in FIGS. 2 and 3.

### DETAILED DESCRIPTION

An embodiment of the present disclosure will be described below in detail with reference to the drawings. The same or corresponding elements in the drawings have the same reference characters allotted and description thereof will not be repeated.

An electric power system according to this embodiment includes a plurality of vehicles. Though the plurality of vehicles in the electric power system may be different from one another in configuration, they are identical in configuration in this embodiment. Each of a plurality of vehicles included in the electric power system is denoted as a “vehicle 50” below and each of a plurality of charging facilities included in the electric power system is denoted as “EVSE 40” below, unless they are described as being distinguished from one another. EVSE means electric vehicle supply equipment.

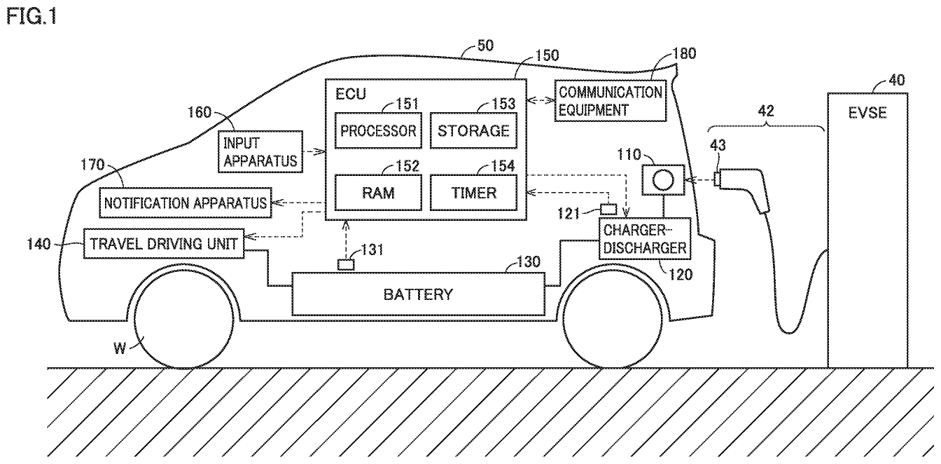

FIG. 1 is a diagram showing a configuration of a vehicle according to this embodiment. Referring to FIG. 1, vehicle 50 includes a battery 130 that stores electric power for traveling. Battery 130 includes a secondary battery such as a lithium ion battery or a nickel metal hydride battery. In this embodiment, a battery assembly including a plurality of lithium ion batteries is adopted as the secondary battery. The battery assembly is composed of a plurality of cells electrically connected to one another. Instead of the secondary battery, another power storage such as an electric double layer capacitor may be adopted. Battery 130 according to this embodiment corresponds to an exemplary “power storage” according to the present disclosure.

Vehicle 50 includes an electronic control unit (which is referred to as an “ECU” below) 150. ECU 150 controls charging and discharging of battery 130. ECU 150 controls communication with the outside of vehicle 50. ECU 150 according to this embodiment functions as a “charging controller” and a “communication controller” according to the present disclosure. Vehicle 50 further includes a monitoring module 131 that monitors a state of battery 130. Monitoring module 131 includes various sensors that detect a state (for example, a voltage, a current, and a temperature) of battery 130 and outputs a result of detection to ECU 150. ECU 150 can obtain a state (for example, a temperature, a current, a voltage, an SOC, and an internal resistance) of battery 130 based on an output (that is, detection values from various sensors) from monitoring module 131. Vehicle 50 may be an electric vehicle (EV) that can travel only with electric power stored in battery 130 or a plug-in hybrid vehicle (PHV) that can travel with both of electric power stored in battery 130 and output from an engine (not shown).

Vehicle 50 can carry out charging of battery 130 by receiving supply of electric power from EVSE 40. Vehicle 50 includes an inlet 110 and a charger-discharger 120 adapted to a power feed type of EVSE 40. Inlet 110 receives electric power supplied from the outside of vehicle 50. Though FIG. 1 shows only inlet 110 and charger-discharger 120, vehicle 50 may include an inlet and a charger-discharger for each power feed type so as to adapt to a plurality of power feed types (for example, an alternating-current (AC) type and a direct-current (DC) type).

A charging cable 42 is connected to EVSE 40. Charging cable 42 may always be connected to EVSE 40 or may be attachable to and removable from EVSE 40. Charging cable 42 includes a connector 43 at its tip end and contains a power line. Connector 43 of charging cable 42 can be connected to inlet 110. As connector 43 of charging cable 42 connected to EVSE 40 is connected to inlet 110 of vehicle 50, EVSE 40 and vehicle 50 are electrically connected to each other. Electric power can thus be supplied from EVSE 40 through charging cable 42 to vehicle 50.

Charger-discharger 120 is located between inlet 110 and battery 130. Charger-discharger 120 includes a relay that switches between connection and disconnection of an electric power path from inlet 110 to battery 130 and a power conversion circuit (neither of which is shown). For example, a bidirectional converter may be adopted as the power conversion circuit. Each of the relay and the power conversion circuit included in charger-discharger 120 is controlled by ECU 150. Vehicle 50 further includes a monitoring module 121 that monitors a state of charger-discharger 120. Monitoring module 121 includes various sensors that detect a state (for example, a voltage, a current, and a temperature) of charger-discharger 120 and outputs a result of detection to ECU 150. In this embodiment, monitoring module 121 detects a voltage and a current input to and output from the power conversion circuit.

As EVSE 40 outside vehicle 50 and inlet 110 are connected to each other through charging cable 42, electric power can be supplied and received between EVSE 40 and vehicle 50. For example, electric power can be supplied from the outside of vehicle 50 to charge battery 130 of vehicle 50 (that is, external charging can be carried out). Electric power for external charging is supplied, for example, from EVSE 40 through charging cable 42 to inlet 110. Charger-discharger 120 converts electric power received at inlet 110 into electric power suitable for charging of battery 130 and outputs resultant electric power to battery 130. As EVSE 40 and inlet 110 are connected to each other through charging cable 42, electric power can be fed from vehicle 50 (and battery 130 can be discharged) through charging cable 42 to EVSE 40. Electric power for external power feed (that is, electric power for power feed to the outside of vehicle 50) is supplied from battery 130 to charger-discharger 120. Charger-discharger 120 converts electric power supplied from battery 130 into electric power suitable for external power feed and outputs resultant electric power to inlet 110. When any of external charging and external power feed is performed, the relay of charger-discharger 120 is closed (connected), and when neither of external charging and external power feed is performed, the relay of charger-discharger 120 is opened (disconnected).

The configuration of charger-discharger 120 is not limited as above and can be modified as appropriate. Charger-discharger 120 may include, for example, at least one of a rectification circuit, a power factor correction circuit, an insulating circuit (for example, an insulating transformer), an inverter, and a filter circuit.

ECU 150 includes a processor 151, a random access memory (RAM) 152, a storage 153, and a timer 154. For example, a central processing unit (CPU) can be adopted as processor 151. RAM 152 functions as a work memory that temporarily stores data to be processed by processor 151. Storage 153 can store information that is put thereinto. Storage 153 includes, for example, a read only memory (ROM) and a rewritable non-volatile memory. Storage 153 stores not only a program but also information (for example, a map, a mathematical expression, and various parameters) to be used by a program. As a program stored in storage 153 is executed by processor 151, various types of control by ECU 150 are carried out in this embodiment. Various types of control by ECU 150 are not limited to control carried out by software but can be carried out by dedicated hardware (electronic circuitry). Any number of processors may be provided in ECU 150 and a processor may be prepared for each prescribed type of control.

Timer 154 notifies processor 151 that the set time has come. As the time set in timer 154 comes, timer 154 transmits a signal to that effect to processor 151. In this embodiment, a timer circuit is adopted as timer 154. Timer 154 may be implemented by software instead of hardware (timer circuitry).

Vehicle 50 further includes a travel driving unit 140, an input apparatus 160, a notification apparatus 170, communication equipment 180, and a drive wheel W. Vehicle 50 is not limited to a front-wheel-drive vehicle shown in FIG. 1 and it may be a rear-wheel-drive vehicle or a four-wheel-drive vehicle.

Travel driving unit 140 includes a not-shown power control unit (PCU) and a motor generator (MG), and allows vehicle 50 to travel with electric power stored in battery 130. The PCU includes, for example, a controller including a processor, an inverter, a converter, and a relay (which is referred to as a “system main relay (SMR)” below) (none of which is shown). The controller of the PCU receives an instruction (a control signal) from ECU 150 and controls the inverter, the converter, and the SMR of the PCU in accordance with the instruction. The MG is implemented, for example, by a three-phase AC motor generator. The MG is driven by the PCU and rotates drive wheel W. The MG performs regeneration and supplies regenerated electric power to battery 130. The SMR switches between connection and disconnection of an electric power path from battery 130 to the PCU. The SMR is closed (connected) when vehicle 50 travels.

Input apparatus 160 accepts an input from a user. Input apparatus 160 is operated by a user and outputs a signal corresponding to the operation by the user to ECU 150. Communication may be wired or wireless. Examples of input apparatus 160 include various switches, various pointing devices, a keyboard, and a touch panel. An operation portion of a car navigation system may be adopted as input apparatus 160.

Notification apparatus 170 performs prescribed processing for giving a notification to a user (for example, a driver and/or a passenger of vehicle 50) when a request is given from ECU 150. Notification apparatus 170 may include at least one of a display apparatus (for example, a touch panel display), a speaker (for example, a smart speaker), and a lamp (for example, a malfunction indicator lamp (MIL)). Notification apparatus 170 may be implemented by a meter panel, a head-up display, or a car navigation system.

Communication equipment 180 includes various communication interfaces (I/F). ECU 150 wirelessly communicates with a communication apparatus outside vehicle 50 through communication equipment 180. Communication equipment 180 may allow vehicle-to-vehicle communication.

An electric power system dependent on a large-scale power plant (an intensive energy resource) possessed by an electric power utility company has recently been reviewed and a scheme for utilizing an energy resource possessed by each demand side (which is also referred to as “demand side resources (DSR)” below) has been constructed. The DSR functions as distributed energy resources (which are also referred to as “DER” below).

A virtual power plant (VPP) has been proposed as a scheme for utilizing the DSR for an electric power system. The VPP refers to a scheme in which a large number of DER (for example, DSR) are put together according to a sophisticated energy management technology that makes use of the Internet of Things (IoT) and the DER are remotely controlled as being integrated as if the DER functioned as a single power plant. In the VPP, an electric utility that puts the DER together to provide an energy management service is referred to as an “aggregator.” An electric power utility company, for example, in coordination with an aggregator, can balance between supply and demand of electric power based on demand response (which is also referred to as “DR” below).

DR is an approach to balancing between supply and demand of electric power by issuing a prescribed request to each demand side by using a demand response signal (which is also referred to as a “DR signal” below). The DR signal is broadly categorized into two types of a DR signal that requests suppression of power demand or backfeeding (which is also referred to as a “DR suppression signal” below) and a DR signal that requests increase in power demand (which is also referred to as a “DR increase signal” below).

A vehicle grid integration (VGI) system is adopted as the electric power system according to this embodiment. In the electric power system according to this embodiment, an electrically powered vehicle (that is, vehicle 50 described above) including a power storage is adopted as DSR for realizing VPP.

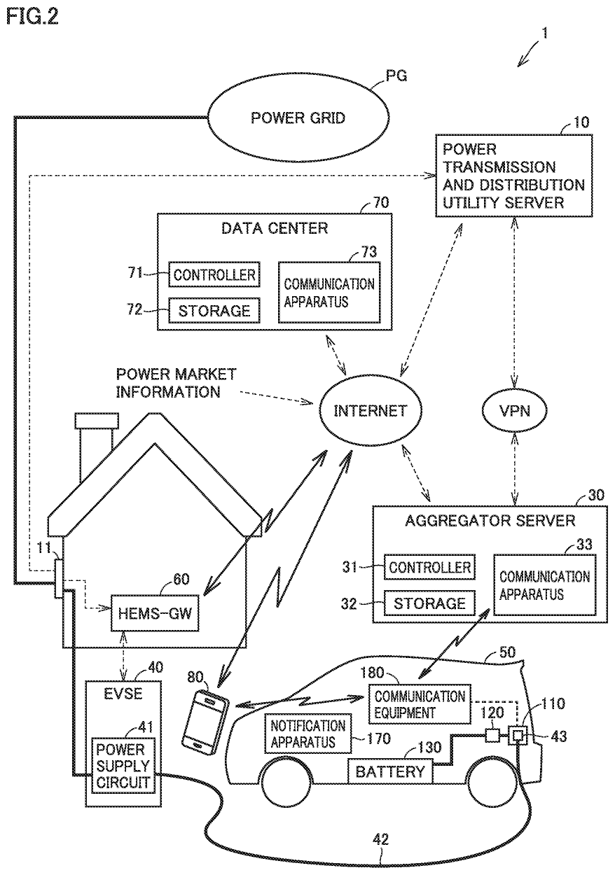

FIG. 2 is a diagram showing a schematic configuration of the electric power system according to this embodiment. A VGI system 1 shown in FIG. 2 corresponds to an exemplary “electric power system” according to the present disclosure. Though FIG. 2 shows only one of each of the vehicle, the EVSE, and an aggregator server, VGI system 1 includes a plurality of vehicles, a plurality of pieces of EVSE, and a plurality of aggregator servers. Any independent number of vehicles, pieces of EVSE, and aggregator servers may be included in VGI system 1, and the number may be set to ten or more or one hundred or more. Each vehicle included in VGI system 1 may be a personally owned vehicle (POV) or a vehicle managed by a mobility as a service (MaaS) entity (MaaS vehicle). Though FIG. 2 shows only a single portable terminal, the portable terminal is carried by each user of the vehicle. Though FIG. 2 illustrates home EVSE, VGI system 1 may include public EVSE that can be used by a large number of unspecified users.

Referring to FIG. 2, VGI system 1 includes a power transmission and distribution utility server 10 (which is also simply referred to as a “server 10” below), a smart meter 11, an aggregator server 30 (which is also simply referred to as a “server 30” below), EVSE 40, vehicle 50 (see FIG. 1), a home energy management system-gateway (HEMS-GW) 60, a data center 70, a portable terminal 80, and a power grid PG. In this embodiment, a smartphone equipped with a touch panel display is adopted as portable terminal 80. Without being limited thereto, any portable terminal can be adopted as portable terminal 80, and for example, a tablet terminal, a portable game console, and a wearable device such as a smart watch can also be adopted.

Server 10 belongs to a power transmission and distribution utility. In this embodiment, an electric power utility company serves also as a power generation utility and a power transmission and distribution utility. The electric power utility company constructs a power network (that is, power grid PG) with a power plant and a power transmission and distribution facility which are not shown, and maintains and manages server 10, smart meter 11, EVSE 40, HEMS-GW 60, and power grid PG. In this embodiment, the electric power utility company corresponds to a system operator that operates power grid PG. The electric power utility company according to this embodiment corresponds to an exemplary “electric utility” according to the present disclosure.

The electric power utility company can make a profit, for example, by dealing with a demand side (for example, an individual or a company) that uses electric power. The electric power utility company provides each demand side with a smart meter. For example, a user of vehicle 50 shown in FIG. 2 is provided with smart meter 11. Identification information (which is also referred to as a “meter ID” below) for identification of each smart meter is provided for each smart meter, and server 10 manages a value of measurement by each smart meter as being distinguished based on the meter ID. The electric power utility company can know an amount of power usage for each demand side based on a value of measurement by each smart meter.

In VGI system 1, identification information (ID) for identification among a plurality of aggregators is provided for each aggregator. Server 10 manages information for each aggregator as being distinguished based on the ID of the aggregator. The aggregator provides an energy management service by putting together amounts of electric power controlled by demand sides under the control thereof. The aggregator can control the amount of electric power by requesting each demand side to level electric power by using a DR signal.

Server 30 belongs to an aggregator. Server 30 includes a controller 31, a storage 32, and a communication apparatus 33. Controller 31 includes a processor, performs prescribed information processing, and controls communication apparatus 33. Storage 32 can store various types of information. Communication apparatus 33 includes various communication interfaces (I/F). Controller 31 communicates with the outside through communication apparatus 33. In VGI system 1, an electrically powered vehicle (for example, a POV or a MaaS vehicle) is adopted as DSR managed by the aggregator (and server 30). A demand side can control an amount of electric power by means of the electrically powered vehicle. Identification information for identification of each vehicle 50 included in VGI system 1 (which is also referred to as a “vehicle ID” below) is provided for each vehicle 50. Server 30 manages information for each vehicle 50 as being distinguished based on the vehicle ID. The aggregator may procure capacity (capability of supply of electricity) not only from vehicle 50 but also from a resource other than vehicle 50 (for example, biomass). The aggregator can make a profit, for example, by dealing with an electric power utility company. The aggregator may be divided into an upper aggregator that contacts the power transmission and distribution utility (for example, the electric power utility company) and a lower aggregator that contacts a demand side.

Data center 70 includes a controller 71, a storage 72, and a communication apparatus 73. Controller 71 includes a processor, performs prescribed information processing, and controls communication apparatus 73. Storage 72 can store various types of information. Communication apparatus 73 includes various types of communication interfaces (I/F). Controller 71 communicates with the outside through communication apparatus 73. Data center 70 manages information on a plurality of registered portable terminals (including portable terminals 80). Information on the portable terminal includes not only information on the terminal itself (for example, a communication address of the portable terminal) but also information on a user who carries the portable terminal (for example, a vehicle ID of vehicle 50 belonging to the user). Identification information for identification of the portable terminal (which is also referred to as a “terminal ID” below) is provided for each portable terminal and data center 70 manages information for each portable terminal as being distinguished based on the terminal ID. The terminal ID also functions as information for identification of a user (a user ID).

Prescribed application software (which is simply referred to as an “application” below) is installed in portable terminal 80, and portable terminal 80 exchanges information with each of HEMS-GW 60 and data center 70 through the application. Portable terminal 80 wirelessly communicates with each of HEMS-GW 60 and data center 70, for example, through the Internet. A user can transmit information representing a state and a schedule of the user to data center 70 by operating portable terminal 80. Exemplary information representing a state of the user includes information indicating whether or not the user is in a condition of being ready for addressing DR. Exemplary information representing the schedule of the user includes time of departure of a POV from home or a drive plan of a MaaS vehicle. Data center 70 stores the information received from portable terminal 80 as being distinguished for each terminal ID.

Server 10 and server 30 can communicate with each other, for example, through a virtual private network (VPN). Each of servers 10 and 30 obtains information on a power market (for example, information on trading of electric power), for example, through the Internet. Server 30 and data center 70 can communicate with each other, for example, through the Internet. Server 30 can obtain information on a user from data center 70. Each of server 30 and data center 70 can communicate with HEMS-GW 60, for example, through the Internet. Though server 30 and EVSE 40 do not communicate with each other in this embodiment, server 30 and EVSE 40 may communicate with each other.

Server 30 sequentially obtains from each vehicle 50, information representing a state of each vehicle 50 (for example, a position of the vehicle, a state of connection of the charging cable, a state of the battery, a charging schedule, a condition for charging, a schedule of travel, and a condition for travel) under the control thereof and stores the information. The state of connection of the charging cable includes information on whether or not the connector of the charging cable is connected to inlet 110. The state of the battery includes a value of an SOC of battery 130 and information indicating whether or not battery 130 is being charged. The charging schedule is information indicating time of start and end of scheduled charging. The condition for charging may be a condition for scheduled charging (for example, charging power) or a condition for charging that is currently ongoing (for example, charging power and a remaining time period of charging). The schedule of travel is information indicating time of start and end of scheduled travel. The condition for travel may be a condition for scheduled travel (for example, a travel route and a travel distance) or a condition for travel that is currently ongoing (for example, a traveling speed and a remaining distance of travel).

Server 10 levels electric power by using demand response (DR). When server 10 levels electric power, initially, the server transmits a signal (which is also referred to as a “DR participation request” below) requesting participation into DR to each aggregator server (including server 30). The DR participation request includes a region of interest of DR, a type of DR (for example, DR suppression or DR increase), and a DR period. When server 30 receives a DR participation request from server 10, it calculates an adjustable DR amount (that is, an amount of electric power that can be adjusted in accordance with DR) and transmits the amount to server 10. Server 30 can calculate the adjustable DR amount, for example, based on a total of DR capacities (that is, capacities for DR) of demand sides under the control thereof.

Server 10 determines a DR amount (that is, an amount of power adjustment asked to an aggregator) for each aggregator based on the adjustable DR amount received from each aggregator server and transmits a signal (which is also referred to as a “DR execution instruction” below) instructing each aggregator server (including server 30) to execute DR. The DR execution instruction includes a region of interest of DR, a type of DR (for example, DR suppression or DR increase), a DR amount for the aggregator, and a DR period. When server 30 receives the DR execution instruction, it allocates the DR amount to each vehicle 50 that can address DR among vehicles 50 under the control thereof, generates a DR signal for each vehicle 50, and transmits the DR signal to each vehicle 50. The DR signal includes a type of DR (for example, DR suppression or DR increase), a DR amount for vehicle 50, and a DR period.

ECU 150 receives a DR signal through communication equipment 180 from the outside of the vehicle. When ECU 150 receives the DR signal, a user of vehicle 50 can contribute to power leveling by carrying out charging or discharging in accordance with the DR signal by using EVSE 40 and vehicle 50. When the user of vehicle 50 has contributed to power leveling, an incentive in accordance with contribution may be paid to the user of vehicle 50 by an electric utility (for example, an electric power utility company or an aggregator) based on an agreement between the user of vehicle 50 and the electric utility.

Vehicle 50 shown in FIG. 2 is electrically connected to outdoor EVSE 40 through charging cable 42 while it is parked in a parking space of a residence (for example, a user's house). EVSE 40 is a non-public charging facility used only by a user and a family member of the user. As connector 43 of charging cable 42 connected to EVSE 40 is connected to inlet 110 of vehicle 50, vehicle 50 and EVSE 40 can communicate with each other and electric power can be supplied from a power supply circuit 41 included in EVSE 40 to vehicle 50 (and battery 130). Power supply circuit 41 converts electric power supplied from power grid PG into electric power suitable for external charging and outputs resultant electric power to charging cable 42.

Power supply circuit 41 is connected to power grid PG provided by the electric power utility company with smart meter 11 being interposed. Smart meter 11 measures an amount of electric power supplied from EVSE 40 to vehicle 50. Smart meter 11 measures an amount of power usage each time a prescribed time period elapses (for example, each time thirty minutes elapse), stores the measured amount of power usage, and transmits the measured amount of power usage to server 10 and HEMS-GW 60. For example, IEC (DLMS/COSEM) can be adopted as a protocol for communication between smart meter 11 and server 10. Server 10 transmits at any time, a value of measurement by smart meter 11 to server 30. Server 10 may transmit the measurement value regularly or upon request from server 30. EVSE 40 may be a charging facility adapted to backfeeding (that is, a charging and discharging facility). Smart meter 11 may measure an amount of electric power backfed from vehicle 50 to EVSE 40.

HEMS-GW 60 transmits information on energy management (for example, information representing a state of use of electric power) to each of server 30, data center 70, and portable terminal 80. HEMS-GW 60 receives a value of measurement of the amount of electric power from smart meter 11. Smart meter 11 and HEMS-GW 60 may communicate with each other in any type of communication, and the type of communication may be a 920-MHz-band low-power wireless communication or power line communication (PLC). HEMS-GW 60 and EVSE 40 can communicate with each other, for example, through a local area network (LAN). The LAN may be wired or wireless LAN.

Communication equipment 180 mounted on vehicle 50 communicates with EVSE 40 through charging cable 42. Communication between EVSE 40 and vehicle 50 may be of any type, and for example, controller area network (CAN) or PLC may be adopted. Communication equipment 180 wirelessly communicates with server 30, for example, through a mobile communication network (telematics). In this embodiment, communication equipment 180 and portable terminal 80 wirelessly communicate with each other. Communication equipment 180 and portable terminal 80 may communicate with each other through short-range communication (for example, direct communication in a vehicle or within an area around the vehicle).

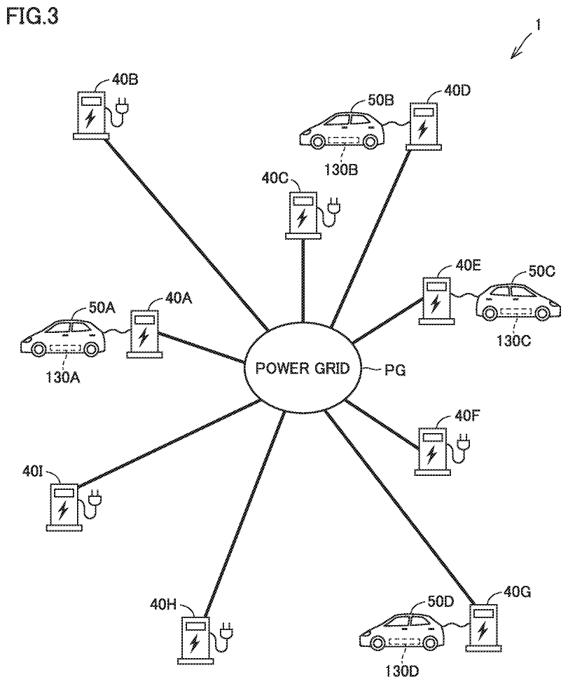

FIG. 3 is a diagram showing an external power supply, a plurality of charging facilities, and a plurality of vehicles included in the electric power system according to this embodiment. Referring to FIG. 3, VGI system 1 includes EVSE 40A to 401, vehicles 50A to 50D, and power grid PG that supplies electric power to each of pieces of EVSE 40A to 401. Vehicles 50A to 50D include externally chargeable batteries 130A to 130D, respectively. Power grid PG is an external power supply (that is, a power supply provided outside vehicles 50A to 50D). Each of vehicles 50A to 50D can electrically be connected to power grid PG through any of pieces of EVSE 40A to 401. In the example shown in FIG. 3, vehicles 50A, 50B, 50C, and 50D are electrically connected to power grid PG through EVSE 40A, 40D, 40E, and 40G, respectively. Power grid PG can supply electric power to vehicles 50A to 50D through EVSE 40A, 40D, 40E, and 40G, respectively.

Power grid PG according to this embodiment corresponds to an exemplary “external power supply (power grid)” according to the present disclosure. Each of pieces of EVSE 40A to 401 according to this embodiment corresponds to an exemplary “charging facility” according to the present disclosure. Vehicle 50A and vehicle 50B according to this embodiment correspond to an exemplary “first vehicle” and an exemplary “second vehicle” according to the present disclosure, respectively. Battery 130A and battery 130B according to this embodiment correspond to an exemplary “first power storage” and an exemplary “second power storage” according to the present disclosure, respectively.

Referring to FIGS. 2 and 3, in VGI system 1, vehicles 50A to 50D carry out external charging successively in the relayed manner by receiving supply of electric power from a common external power supply (that is, power grid PG). It is vehicle 50A that carries out external charging in the first place (which is also referred to as an “earliest vehicle” below) among vehicles 50A to 50D, and vehicles carry out external charging in the order of vehicle 50A, vehicle 50B, vehicle 50C, and vehicle 50D. The method of charging in the relayed manner in a plurality of vehicles is also referred to as “relayed charging” below. A group constituted of a plurality of vehicles that carry out relayed charging in cooperation is also referred to as a “charging group.”

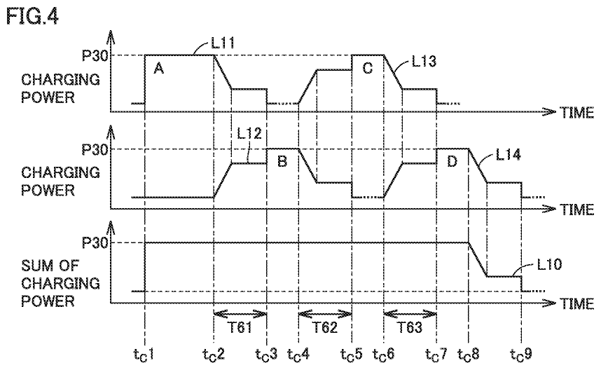

FIG. 4 is a diagram for illustrating relayed charging carried out in vehicles 50A to 50D. In FIG. 4, lines L11 to L14 represent transition of charging power for batteries 130A to 130D in respective vehicles 50A to 50D. A line L10 represents the sum of charging power in all vehicles (that is, vehicles 50A to 50D) that constitute one charging group.

Referring to FIG. 4 together with FIGS. 2 and 3, server 30 requests vehicle 50A to increase demand for electric power supplied by power grid PG by transmitting a DR increase signal to vehicle 50A. When vehicle 50A receives a charging start command from server 30 while it is electrically connected to power grid PG after vehicle 50A receives the DR increase signal from server 30, vehicle 50A starts external charging of battery 130A with electric power supplied from power grid PG in response to the request in the DR increase signal.

Vehicle 50A transmits a first end prediction signal that predicts end of the started external charging to server 30 before end of the started external charging. In the example in FIG. 4, the first end prediction signal is transmitted at timing t_{C}2. When server 30 receives the first end prediction signal from vehicle 50A, it transmits a first start signal to vehicle 50B.

When vehicle 50B receives the first start signal while it is electrically connected to power grid PG, vehicle 50B starts the external charging of battery 130B with electric power supplied from power grid PG before end of the external charging started in vehicle 50A. In the example in FIG. 4, the external charging of battery 130B is started at timing substantially the same as timing t_{C}2 (more specifically, timing later by time required for communication through server 30). Thereafter, at timing t_{C}3, the external charging of battery 130A in vehicle 50A ends. For a period T61 in FIG. 4, external charging of battery 130A in vehicle 50A and the external charging of battery 130B in vehicle 50B are both carried out simultaneously.

Vehicle 50B transmits a second end prediction signal predicting end of the external charging started in response to reception of the first start signal to server 30 before end of the external charging. In the example in FIG. 4, the second end prediction signal is transmitted at timing t_{C}4. When server 30 receives the second end prediction signal from vehicle 50B, it transmits a second start signal to vehicle 50C.

When vehicle 50C receives the second start signal while it is electrically connected to power grid PG, vehicle 50C starts external charging of battery 130C with electric power supplied from power grid PG before end of the external charging started in vehicle 50B. In the example in FIG. 4, the external charging of battery 130C is started at timing substantially the same as timing t_{C}4 (more specifically, timing later by time required for communication through server 30). Thereafter, at timing t_{C}5, the external charging of battery 130B in vehicle 50B ends. For a period T62 in FIG. 4, the external charging of battery 130B in vehicle 50B and the external charging of battery 130C in vehicle 50C are both carried out simultaneously.

Vehicle 50C transmits a third end prediction signal predicting end of the external charging started in response to reception of the second start signal to server 30 before end of the external charging. In the example in FIG. 4, the third end prediction signal is transmitted at timing t_{C}6. When server 30 receives the third end prediction signal from vehicle 50C, it transmits a third start signal to vehicle 50D.

When vehicle 50D receives the third start signal while it is electrically connected to power grid PG, vehicle 50D starts external charging of battery 130D with electric power supplied from power grid PG before end of the external charging started in vehicle 50C. In the example in FIG. 4, the external charging of battery 130D is started at timing substantially the same as timing t_{C}6 (more specifically, timing later by time required for communication through server 30). Thereafter, at timing t_{C}7, the external charging of battery 130C in vehicle 50C ends. Further thereafter, at timing t_{C}9, the external charging of battery 130D in vehicle 50D ends. For a period T63 in FIG. 4, the external charging of battery 130C in vehicle 50C and the external charging of battery 130D in vehicle 50D are both carried out simultaneously.

In VGI system 1 described above, when vehicles 50A to 50D carry out relayed charging, a part just before end of the period of charging in a vehicle earlier in charging start time overlaps with a part immediately after start of the period of charging in a vehicle later in charging start time. Therefore, there is no charging discontinuity at the time of succession between the vehicles and external charging in vehicles 50A to 50D is continuously carried out. Each of periods T61 to T63 in FIG. 4 corresponds to an exemplary “overlapping charging period.” Each of the first to third start signals according to this embodiment corresponds to an exemplary “start signal” according to the present disclosure.

Vehicle 50A carries out external charging with constant electric power P30 during a period from timing t_{C}1 to timing t_{C}2 (see line L11). Vehicle 50B carries out external charging with constant electric power P30 during a period from timing t_{C}3 to timing t_{C}4 (see line L12). Vehicle 50C carries out external charging with constant electric power P30 during a period from timing t_{C}5 to timing t_{C}6 (see line L13). Vehicle 50D carries out external charging with constant electric power P30 during a period from timing t_{C}7 to timing t_{C}8 (see line L14). Controller 31 of server 30 controls vehicles 50A to 50D to keep the sum of charging power (that is, total sum electric power) for external charging simultaneously carried out for the overlapping charging period (periods T61 to T63) at electric power P30. Therefore, the sum of charging power for vehicles 50A to 50D that constitute the charging group is constant during a period from timing t_{C}1 to timing t_{C}8 (see line L10). Controller 31 according to this embodiment corresponds to an exemplary “electric power controller” according to the present disclosure.

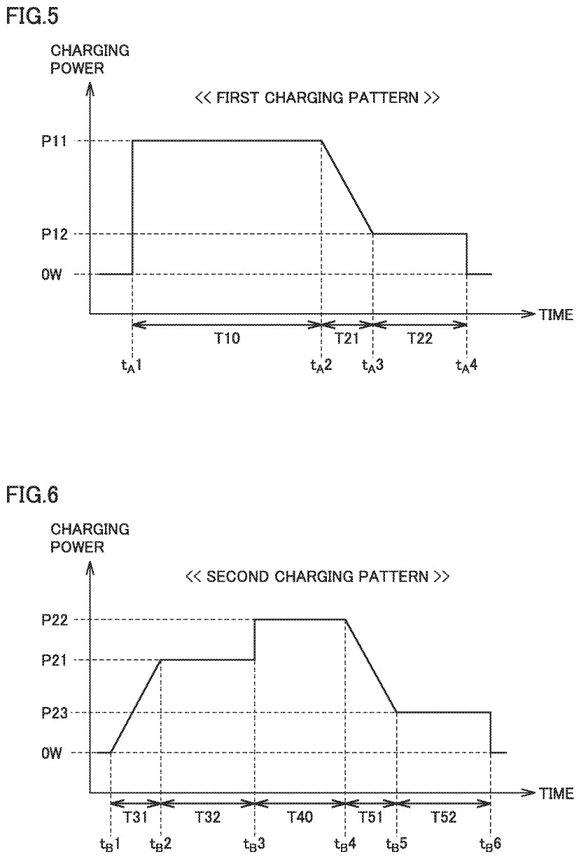

In this embodiment, the earliest vehicle (that is, vehicle 50A) among vehicles 50A to 50D carries out external charging in a first charging pattern and other vehicles (that is, vehicles 50B to 50D) carry out external charging in a second charging pattern. The first charging pattern and the second charging pattern will be described below with reference to FIGS. 5 and 6.

FIG. 5 is a diagram showing the first charging pattern adopted in the electric power system according to this embodiment. Referring to FIG. 5, the first charging pattern includes a charging period T10 (from timing tall to timing t_{A}2) immediately after start of charging, a charging period T21 (from timing t_{A}2 to timing t_{A}3) following charging period T10, and a charging period T22 (from timing t_{A}3 to timing t_{A}4) following charging period T21. Timing tall corresponds to charging start timing and timing t_{A}4 corresponds to charging end timing.

Charging period T10 is a period during which external charging with constant electric power P11 is carried out. Each of charging periods T21 and T22 is a period during which external charging with electric power lower than electric power P11 is carried out. Charging period T22 is a period during which external charging with constant electric power P12 lower than electric power P11 is carried out. Charging period T21 is a period during which charging power is lowered from electric power P11 to electric power P12. Though charging power is lowered at a constant rate during charging period T21 in the example in FIG. 5, a rate of lowering in charging power does not have to be constant. For example, a rate of lowering in charging power may gradually be increased or decreased during charging period T21. Alternatively, charging power may be lowered stepwise during charging period T21. Electric power P11 according to this embodiment corresponds to exemplary “first electric power” according to the present disclosure. Charging period T10 (from timing t_{A}1 to timing t_{A}2) according to this embodiment corresponds to an exemplary “first charging period” according to the present disclosure. Charging periods T21 and T22 (from timing t_{A}2 to timing t_{A}4) according to this embodiment correspond to an exemplary “second charging period” according to the present disclosure.

ECU 150 (FIG. 1) of vehicle 50A (FIG. 3) carries out external charging of battery 130A (FIG. 3) in the first charging pattern as above. The first charging pattern is stored in storage 153 (FIG. 1) in advance. Each of timing t_{A}1 to timing t_{A}4 is not fixed but is variable depending on a situation. ECU 150 of vehicle 50A determines timing t_{A}1 in response to a charging start command received from server 30 (FIG. 2) and determines timing t_{A}2 to timing t_{A}4 in accordance with a status of charging of battery 130A. ECU 150 of vehicle 50A transmits the first end prediction signal to server 30 at timing t_{A}2 (that is, at the end of charging period T10). ECU 150 of vehicle 50A according to this embodiment corresponds to an exemplary “first charging controller” according to the present disclosure.

FIG. 6 is a diagram showing the second charging pattern adopted in the electric power system according to this embodiment. Referring to FIG. 6, the second charging pattern includes a charging period T31 (from timing t_{B}1 to timing t_{B}2) immediately after start of charging, a charging period T32 (from timing t_{B}2 to timing t_{B}3) following charging period T31, a charging period T40 (from timing t_{B}3 to timing t_{B}4) following charging period T32, a charging period T51 (from timing t_{B}4 to timing t_{B}5) following charging period T40, and a charging period T52 (from timing t_{B}5 to timing t_{B}6) following charging period T51. Timing t_{B}1 corresponds to charging start timing and timing t_{B}6 corresponds to charging end timing.

Charging period T40 is a period during which external charging with constant electric power P22 is carried out. Each of charging periods T31, T32, T51, and T52 is a period during which external charging with electric power lower than electric power P22 is carried out. Charging period T32 is a period during which external charging with electric power P21 lower than electric power P22 is carried out. Charging period T31 is a period during which charging power is increased from 0 W to electric power P21. Though charging power is increased at a constant rate during charging period T31 in the example in FIG. 6, a rate of increase in charging power does not have to be constant. For example, a rate of increase in charging power may gradually be increased or decreased during charging period T31. Alternatively, charging power may be increased stepwise during charging period T31. Charging period T52 is a period during which external charging with constant electric power P23 lower than electric power P21 is carried out. Charging period T51 is a period during which charging power is lowered from electric power P22 to electric power P23. Though charging power is lowered at a constant rate during charging period T51 in the example in FIG. 6, a rate of lowering in charging power does not have to be constant. For example, a rate of lowering in charging power may gradually be increased or decreased during charging period T51. Alternatively, charging power may be lowered stepwise during charging period T51. Electric power P22 according to this embodiment corresponds to exemplary “second electric power” according to the present disclosure. Charging periods T31 and T32 (from timing t_{B}1 to timing t_{B}3) according to this embodiment correspond to an exemplary “third charging period” according to the present disclosure. Charging period T40 (from timing t_{B}3 to timing t_{B}4) according to this embodiment corresponds to an exemplary “fourth charging period” according to the present disclosure.

ECU 150 (FIG. 1) of vehicle 50B (FIG. 3) carries out external charging of battery 130B (FIG. 3) in the second charging pattern as above. The second charging pattern is stored in storage 153 (FIG. 1) in advance. Each of timing t_{B}1 to timing t_{B}6 is not fixed but is variable depending on a situation. ECU 150 of vehicle 50B determines timing t_{B} 1 in response to the first start signal received from server 30 (FIG. 2), determines timing t_{B}2 and timing t_{B}3 in response to a charging power command received from server 30, and determines timing t_{B}4 to timing t_{B}6 in accordance with a status of charging of battery 130B. ECU 150 of vehicle 50B transmits the second end prediction signal to server 30 at timing t_{B}4 (that is, at the end of charging period T40). ECU 150 of vehicle 50B according to this embodiment corresponds to an exemplary “second charging controller” according to the present disclosure.

As set forth above, constant power charging is carried out for each of charging period T10 (FIG. 5) in the first charging pattern and charging period T40 (FIG. 6) in the second charging pattern. In this embodiment, electric power P11 during charging period T10 and electric power P22 during charging period T40 (FIG. 6) are equal to each other. Each of charging periods T10 and T40 is denoted as a “CP1 period” below except for an example where they are described as being distinguished from each other. Charging power during the CP1 period is denoted as “charging power P31.” In this embodiment, while vehicle 50 is receiving a request relating to charging power from server 30, charging power is determined in accordance with the request from server 30. Server 30 may adopt charging power highest in charging rate (for example, maximum electric power that can be output from charger-discharger 120 shown in FIG. 1 to battery 130) as charging power P31.

In charging battery 130 to full charge, ECU 150 carries out constant power charging with high charging power P31 during the CP1 period until battery 130 is close to full charge. When battery 130 is close to full charge and a voltage of battery 130 is equal to or higher than an open circuit voltage (OCV) at the time of full charge, storage of electricity in battery 130 with high charging power becomes hard. Therefore, when battery 130 is close to full charge, ECU 150 carries out charging for bringing battery 130 closer to full charge with low charging power (which is also referred to as “forced-in charging” below).

For each of charging period T22 (FIG. 5) in the first charging pattern and charging period T52 (FIG. 6) in the second charging pattern, constant power charging is carried out This constant power charging corresponds to forced-in charging. In this embodiment, electric power P12 during charging period T22 and electric power P23 (FIG. 6) during charging period T52 are equal to each other. Each of charging periods T22 and T52 is denoted as a “CP2 period” below except for an example where they are described as being distinguished from each other. Charging power during the CP2 period is denoted as “charging power P32.” In this embodiment, charging power P32 is set as electric power suitable for forced-in charging.

During each of charging period T21 (FIG. 5) in the first charging pattern and charging period T51 (FIG. 6) in the second charging pattern, constant voltage charging is carried out. Each of charging periods T21 and T51 is denoted as a “CV period” below except for an example where they are described as being distinguished from each other. A charging voltage during the CV period is denoted as a “charging voltage V30.” During the CV period, the charging voltage is constant (charging voltage V30) and charging power gradually lowers. Charging power during the CV period is lowered from charging power P31 to charging power P32.

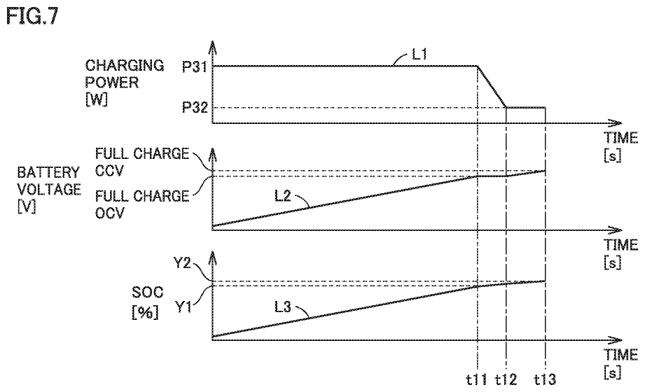

FIG. 7 is a timing chart for illustrating the CP1 period, the CV period, and the CP2 period. In FIG. 7, a line L1 represents transition of charging power for battery 130. A line L2 represents transition of a voltage of battery 130 (a battery voltage). A line L3 represents transition of an SOC of battery 130.

Referring to FIG. 7 together with FIG. 1, in this timing chart, a period before timing t11 corresponds to the CP1 period. When the SOC (line L3) of battery 130 reaches a threshold value Y1 at timing t11, transition from the CP1 period to the CV period is made. In this embodiment, when the voltage (line L2) of battery 130 attains to the OCV at the time of full charge, the SOC of battery 130 attains to threshold value Y1.

A period from timing t11 to timing t12 corresponds to the CV period. When charging power (line L1) for battery 130 attains to charging power P32 at timing t12, transition from the CV period to the CP2 period is made. Thereafter, when the SOC (line L3) of battery 130 reaches a threshold value Y2 (for example, 100%) larger than threshold value Y1 at timing t13, charging ends. In this embodiment, the SOC of battery 130 attains to threshold value Y2 when the voltage (line L2) of battery 130 attains to a closed circuit voltage (CCV) at the time of full charge.

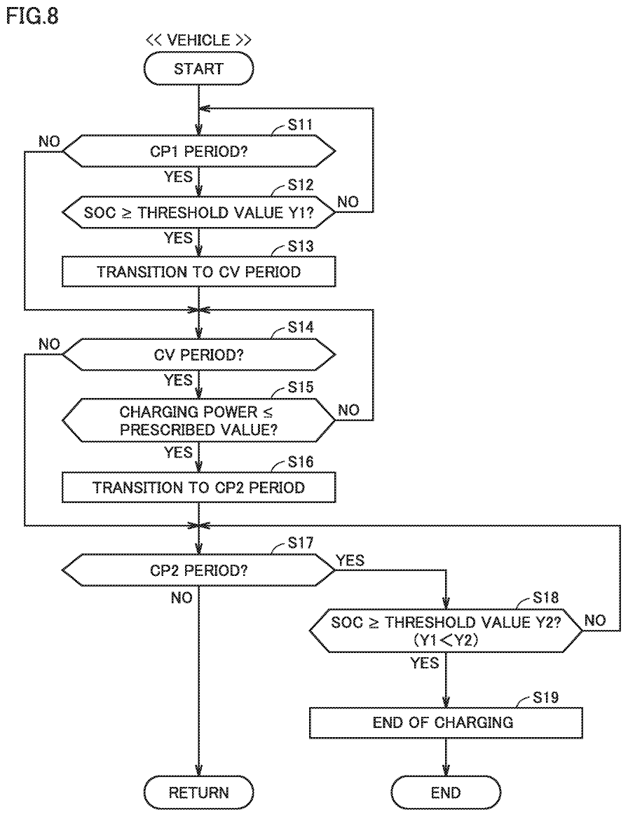

FIG. 8 is a flowchart showing charging control carried out by ECU 150 of each vehicle 50 included in the electric power system according to this embodiment. Processing shown in this flowchart is repeatedly performed while vehicle 50 carries out external charging of battery 130.

Referring to FIG. 8 together with FIGS. 1 and 7, in a step (which is simply denoted as “S” below) 11, ECU 150 determines whether or not a current status falls under the CP1 period (that is, whether or not constant power charging during the CP1 period is being carried out). When the current status does not fall under the CP1 period (NO in S11), in S14, ECU 150 determines whether or not the current status falls under the CV period (that is, whether or not constant voltage charging during the CV period is being carried out). When the current status does not fall under the CV period (NO in S14), in S17, ECU 150 determines whether or not the current status falls under the CP2 period (that is, constant power charging during the CP2 period is being carried out). When the current status does not fall under the CP2 period (NO in S17), the process returns to S11.

When charging power attains to charging power P31 after start of external charging of battery 130, ECU 150 starts constant power charging during the CP1 period. Thus, it is determined that the current status falls under the CP1 period (YES in S11) and the process proceeds to S12. In S12, ECU 150 determines whether or not the SOC of battery 130 is equal to or larger than threshold value Y1. ECU 150 can find the SOC of battery 130, for example, based on a voltage of battery 130 detected by monitoring module 131. While the SOC of battery 130 is determined as being smaller than threshold value Y1 (NO in S12), constant power charging during the CP1 period is continued. When the SOC of battery 130 is determined as being equal to or larger than threshold value Y1 (YES in S12), in S13, ECU 150 quits the CP1 period and makes transition to the CV period. Thus, it is determined that the current status falls under the CV period (YES in S14) and the process proceeds to S15.

In S15, ECU 150 determines whether or not charging power is equal to or smaller than a prescribed value (charging power P32 in this embodiment). While charging power is determined as being higher than charging power P32 (NO in S15), constant voltage charging during the CV period is continued. When charging power attains to charging power P32 with lowering in charging power during the CV period, charging power is determined as being equal to or smaller than the prescribed value (YES in S15) and the process proceeds to S16. In S16, ECU 150 quits the CV period and makes transition to the CP2 period. It is thus determined that the current status falls under the CP2 period (YES in S17) and the process proceeds to S18.

In S18, ECU 150 determines whether or not the SOC of battery 130 is equal to or larger than threshold value Y2 (100% in this embodiment). While the SOC of battery 130 is determined as being smaller than threshold value Y2 (NO in S18), constant power charging (that is, forced-in charging described previously) during the CP2 period is continued. When the SOC of battery 130 is determined as being equal to or larger than threshold value Y2 (YES in S18), in S19, ECU 150 quits external charging and quits a series of processing in FIG. 8.

In the above, the SOC of battery 130 at the time when the voltage of battery 130 attains to the OCV at the time of full charge is defined as threshold value Y1. Without being limited as such, threshold value Y1 may be changed by a user. When the user performs a prescribed resetting operation onto input apparatus 160 (FIG. 1) after the user changed threshold value Y1, threshold value Y1 set in ECU 150 may return to an initial value (for example, the SOC of battery 130 at the time when the voltage of battery 130 attains to the OCV at the time of full charge).

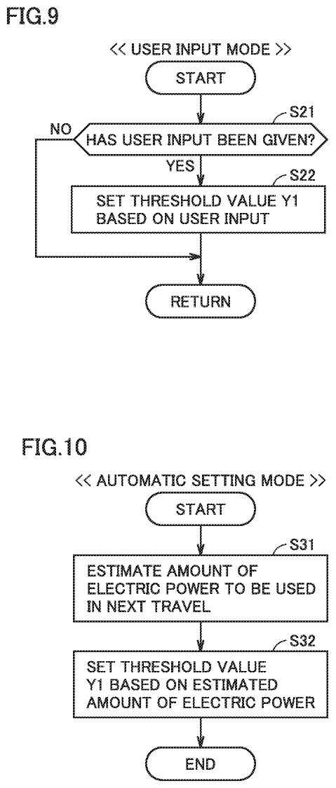

ECU 150 may accept input of an SOC value by a user and set threshold value Y1 based on the SOC value input by the user. FIG. 9 is a flowchart showing processing involved with setting of threshold value Y1 (more specifically, processing in a user input mode) performed by ECU 150. Processing shown in this flowchart is repeatedly performed while the user input mode has been set as the mode of setting threshold value Y1. The user can switch between modes of setting threshold value Y1, for example, by operating input apparatus 160 (FIG. 1).

Referring to FIG. 9 together with FIG. 1, in S21, ECU 150 determines whether or not the user has operated input apparatus 160 to input an SOC value. While it is determined that the user has not given any input (NO in S21), processing in S21 is repeatedly performed. When it is determined that the user has given an input (YES in S21), the process proceeds to S22.

In S22, ECU 150 sets the SOC value input by the user as threshold value Y1. Set threshold value Y1 is stored in storage 153 (FIG. 1).

As threshold value Y1 to be used in S12 in FIG. 8 described previously is set as above, the timing of transition from the CP1 period to the CV period can be determined by the user.

ECU 150 may estimate an amount of electric power to be used in next travel and set threshold value Y1 based on the estimated amount of electric power. FIG. 10 is a flowchart showing processing involved with setting of threshold value Y1 (more specifically, processing in an automatic setting mode) performed by ECU 150. Processing shown in this flowchart is performed at prescribed timing while the automatic setting mode has been set as the mode of setting threshold value Y1. For example, the processing is performed immediately before start of external charging of battery 130 in vehicle 50.

Referring to FIG. 10 together with FIG. 1, in S31, ECU 150 estimates an amount of electric power to be used in next travel. Any estimation method is applicable. For example, ECU 150 may record in storage 153, a history of travel (for example, a distance and a time period of travel in one trip and an amount of electric power used in one trip) each time travel of vehicle 50 ends. ECU 150 may estimate an amount of electric power to be used in next travel based on an average value of data (history of travel) recorded in storage 153. Alternatively, ECU 150 may estimate an amount of electric power to be used in next travel by a known machine learning technology or artificial intelligence using big data including detailed conditions for travel in past travels.

In S32, ECU 150 sets threshold value Y1 based on the amount of electric power estimated in S31. More specifically, ECU 150 sets as threshold value Y1, the SOC value of battery 130 at the time when the amount of electric power estimated in S31 matches with the amount of electric power stored in battery 130. Set threshold value Y1 is stored in storage 153 (FIG. 1).

As threshold value Y1 to be used in S12 in FIG. 8 described previously is set as above, transition from the CP1 period to the CV period can be made at timing when the amount of electric power to be used in next travel could be secured in battery 130.

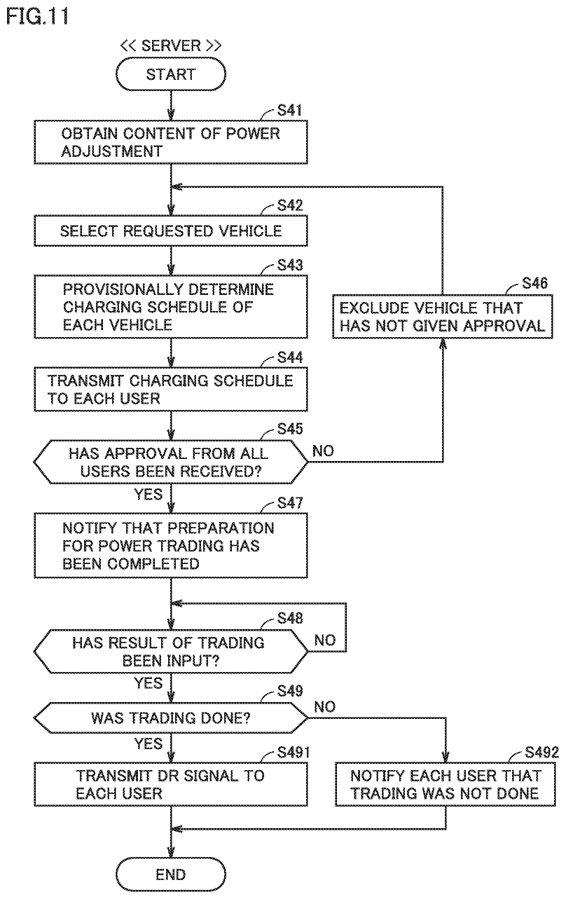

FIG. 11 is a flowchart showing processing performed by controller 31 of server 30 when an aggregator trades electric power in a power market. Processing shown in this flowchart is started when contents of adjustment of electric power (which is also referred to as “requested contents” below) requested in the power market are input by the aggregator into server 30 when increase in demand for electric power supplied by power grid PG is requested in the power market.

Referring to FIG. 11 together with FIG. 2, in S41, controller 31 of server 30 obtains requested contents (that is, contents of adjustment of electric power) input by the aggregator. The requested contents include charging power and a requested period (that is, a charging period).

In S42, controller 31 selects a vehicle to which a request for adjustment of electric power is to be issued (which is also referred to as a “requested vehicle” below) from among vehicles 50 under the control thereof. The controller selects requested vehicles that fulfill the requested contents as many as needed. In S43, controller 31 provisionally determines a charging schedule (that is, time of start and end of charging) of each requested vehicle selected in S42. Controller 31 may select a requested vehicle in S42 and may provisionally determine a charging schedule in S43, by referring to information representing a state of each vehicle 50 (for example, a position of the vehicle, a state of connection of the charging cable, a state of the battery, a charging schedule, a condition for charging, a schedule of travel, and a condition for travel) under the control thereof.

In S44, controller 31 controls communication apparatus 33 to transmit the provisionally determined charging schedule to a user of each requested vehicle and requests the user to give an answer (answerback) as to whether or not the user approves the charging schedule. The charging schedule may be transmitted to communication equipment 180 mounted on the requested vehicle or to portable terminal 80 (FIG. 2) carried by the user of the requested vehicle.

In S45, controller 31 determines whether or not all users to which the charging schedule was sent have given an answer to the effect that they approve the charging schedule. This determination is made, for example, at timing of reception of the answer from all users to which the charging schedule was sent or timing of lapse of a prescribed time period since transmission of the charging schedule. In this embodiment, a user who has not transmitted an answer even after lapse of a prescribed time period since transmission of the charging schedule is handled similarly to a user who has answered that he/she does not approve the charging schedule.

When it is determined that one of the users has not approved the charging schedule (NO in S45), in S46, controller 31 excludes a vehicle belonging to the user who has not approved the charging schedule from candidates for the requested vehicle. Thereafter, the process returns to S42. The vehicle excluded in S46 is not selected in S42. While determination as NO is made in S45, S42 to S46 are repeatedly performed.

When it is determined that all users have approved the charging schedule (YES in S45), in S47, controller 31 notifies the aggregator of completion of preparation for trading of electric power through a not-shown notification apparatus (for example, a touch panel display). Approval of the charging schedule by the user of the requested vehicle means that the user has promised the aggregator that the user carries out charging in accordance with a command from server 30 by having the requested vehicle stand by in an externally chargeable state (for example, a state that the vehicle is connected to EVSE 40 through charging cable 42 shown in FIG. 2) for a period indicated by the charging schedule.

As DSR (vehicle 50) for adjustment of electric power is thus secured, the aggregator can trade electric power in the power market, for example, through Japan Electric Power Exchange (JEPX). The aggregator may also make a bid. When trading ends, the aggregator inputs a result (done/not done) of trading into server 30.

After controller 31 of server 30 performs notification processing in S47, in S48, it waits for input from the aggregator. Then, when the result (done/not done) of trading is input from the aggregator (YES in S48), in S49, controller 31 determines whether or not trading of electric power was done. When trading of electric power was done (YES in S49), in 5491, controller 31 controls communication apparatus 33 to transmit a DR signal (more specifically, a DR increase signal that requests increase in demand for electric power supplied by power grid PG) to the user of each requested vehicle. The DR increase signal includes the charging schedule and charging power (in this embodiment, electric power P30 shown in FIG. 4). By keeping the promise (see S45), the user who has received the DR signal can be rewarded with an incentive from the aggregator. On the other hand, a penalty is imposed on a user who has broken the promise. When trading was not done (NO in S49), in 5492, controller 31 controls communication apparatus 33 to notify the user of each requested vehicle that trading was not done. The promise is withdrawn by this notification.

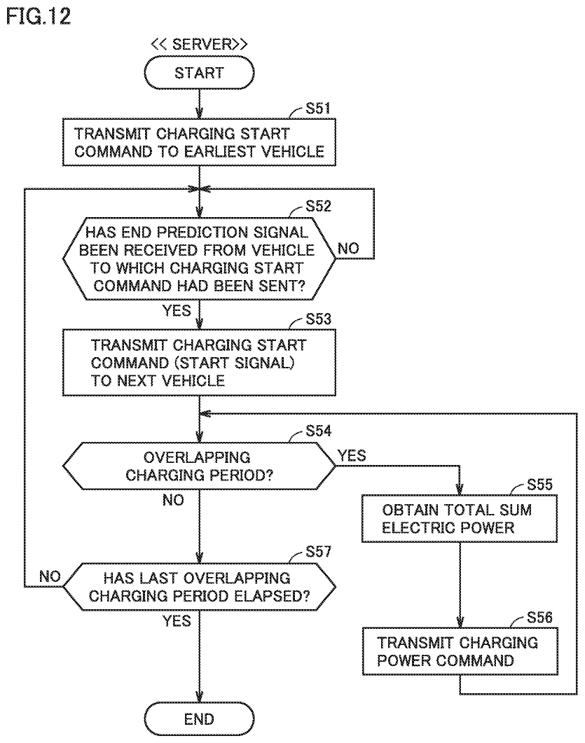

FIG. 12 is a flowchart showing processing involved with relayed charging performed by controller 31 of server 30. An example in which controller 31 transmits in S491 in FIG. 11, a DR increase signal to a user of each of vehicles 50A to 50D shown in FIG. 3 and thereafter controller 31 performs processing in FIG. 12 to have vehicles 50A to 50D carry out relayed charging will be described below. A series of processing shown in FIG. 12 is started, for example, when charging start time in the charging schedule indicated by the DR increase signal transmitted from server 30 to the user of the earliest vehicle (that is, vehicle 50A) comes. The charging start time in the charging schedule indicated by the DR increase signal may come several hours after timing of transmission of the DR increase signal or on the next day or later.

Referring to FIG. 12 together with FIGS. 2 to 4, in S51, controller 31 controls communication apparatus 33 to transmit a charging start command to the earliest vehicle (that is, vehicle 50A). External charging in vehicle 50A is thus started (timing t_{C}1 in FIG. 4). Then, in S52, controller 31 waits for an end prediction signal from the vehicle (that is, vehicle 50A) to which the controller has sent the charging start command. At timing t_{C}2 in FIG. 4, vehicle 50A transmits the first end prediction signal. When server 30 receives the first end prediction signal from vehicle 50A (YES in S52), in S53, controller 31 controls communication apparatus 33 to transmit the first start signal to the next vehicle (that is, vehicle 50B). The first start signal corresponds to the charging start command. External charging in vehicle 50B is thus started. In succession, in S54, controller 31 determines whether or not the current status falls under the overlapping charging period (that is, whether or not external charging in vehicle 50A and external charging in vehicle 50B are both simultaneously carried out). During period T61 shown in FIG. 4, it is determined that the current status falls under the overlapping charging period (YES in S54) and processing in S55 and S56 described below is repeatedly performed.

In S55, controller 31 obtains the sum of charging power in external charging simultaneously carried out for the overlapping charging period. During period T61 shown in FIG. 4, the sum of charging power for battery 130A and charging power for battery 130B is obtained by controller 31. Controller 31 may obtain charging power based on a value of measurement by each smart meter or obtain from each vehicle, charging power measured in each vehicle.

In S56, controller 31 controls charging power in a later vehicle (that is, a vehicle where charging is started later) of two vehicles that carry out external charging, so as to keep the sum of charging power for external charging simultaneously carried out for the overlapping charging period constant (in this embodiment, electric power P30 shown in FIG. 4). During period T61 shown in FIG. 4, vehicles 50A and 50B are carrying out external charging, and vehicle 50A corresponds to a “preceding vehicle” and vehicle 50B corresponds to a “later vehicle.” In S56, controller 31 transmits to vehicle 50B, a charging power command that requests external charging with charging power calculated by subtracting charging power for battery 130A from electric power P30. Vehicle 50B is controlled in accordance with the charging power command. The sum of charging power for battery 130A and charging power for battery 130B during period T61 is thus kept at electric power P30.

When period T61 shown in FIG. 4 elapses, it is determined that the current status does not fall under the overlapping charging period (NO in S54) and the process proceeds to S57. In S57, controller 31 determines whether or not the last overlapping charging period (that is, period T63 shown in FIG. 4) in relayed charging in vehicles 50A to 50D has elapsed. When the last overlapping charging period has not elapsed (NO in S57), the process returns to S52.

In S52, controller 31 waits for the end prediction signal from a vehicle (that is, vehicle 50B) following vehicle 50A. When the second end prediction signal is transmitted from vehicle 50B at timing t_{C}4 in FIG. 4, determination as YES is made in S52, and in S53, controller 31 transmits the second start signal to a vehicle (that is, vehicle 50C) following vehicle 50B. The second start signal corresponds to the charging start command. External charging in vehicle 50C is thus started. Then, during period T62 shown in FIG. 4, determination as YES is made in S54, and processing in S55 and S56 is repeatedly performed. The sum of charging power for battery 130B and charging power for battery 130C during period T62 is thus kept at electric power P30.

When period T62 shown in FIG. 4 elapses, determination as NO is made in both of S54 and S57 and the process returns to S52. In S52, controller 31 waits for the end prediction signal from a vehicle (that is, vehicle 50C) following vehicle 50B. When the third end prediction signal is transmitted from vehicle 50C at timing t_{C}6 in FIG. 4, determination as YES is made in S52, and in S53, controller 31 transmits the third start signal to a vehicle (that is, vehicle 50D) following vehicle 50C. The third start signal corresponds to the charging start command. External charging in vehicle 50D is thus started. During period T63 shown in FIG. 4, determination as YES is made in S54 and processing in S55 and S56 is repeatedly performed. The sum of charging power for battery 130C and charging power for battery 130D during period T63 is thus kept at electric power P30. When period T63 elapses, it is determined that the last overlapping charging period has elapsed (YES in S57) and a series of processing in FIG. 12 ends.

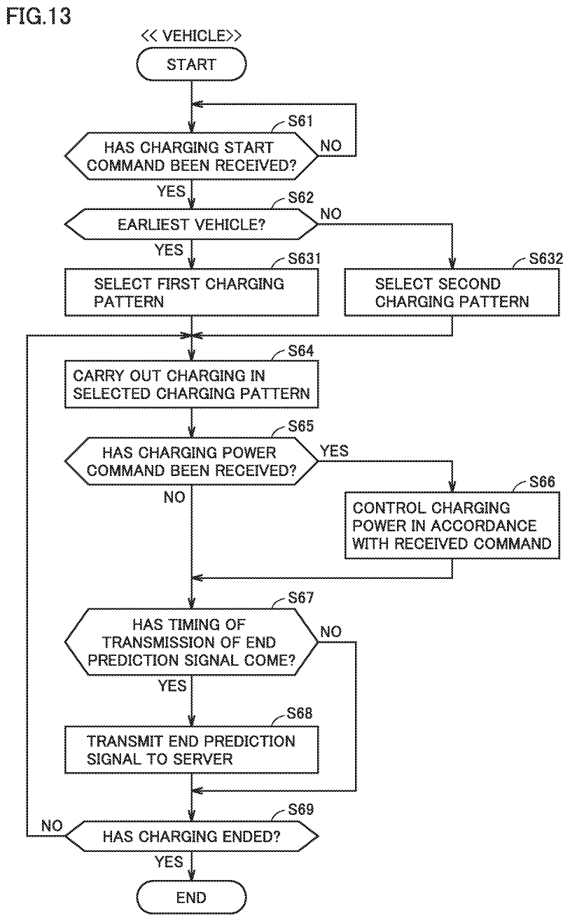

FIG. 13 is a flowchart showing processing involved with relayed charging performed by ECU 150 of each vehicle 50 included in the electric power system according to this embodiment. Processing shown in this flowchart is started when charging start time in the charging schedule indicated by a DR increase signal received by each vehicle 50 comes. The charging schedule indicated by the DR increase signal (and the timing of start of processing in FIG. 13) is different for each vehicle.

Referring to FIG. 13 together with FIGS. 2 to 4, in S61, ECU 150 waits for the charging start command. In vehicle 50A, when the vehicle receives the charging start command (S51 in FIG. 12) from server 30, in S61, ECU 150 makes determination as YES. In vehicles 50B, 50C, and 50D, when the vehicles receive the first start signal, the second start signal, and the third start signal from server 30 (S53 in FIG. 12), respectively, ECU 150 makes determination as YES in S61.

When it is determined that the vehicle has received the charging start command (YES in S61), in S62, ECU 150 determines whether or not the vehicle is the earliest vehicle (that is, the vehicle is the earliest in external charging in relayed charging). Among vehicles 50A to 50D, vehicle 50A is the earliest vehicle. For vehicle 50A, determination as YES is made in S62, ECU 150 selects the first charging pattern (FIG. 5) in 5631, and ECU 150 carries out external charging in the first charging pattern in S64. For each of vehicles 50B to 50D, determination as NO is made in S62, ECU 150 selects the second charging pattern (FIG. 6) in 5632, and ECU 150 carries out external charging in the second charging pattern in S64. The first charging pattern and the second charging pattern are stored in advance in storage 153 (FIG. 1) of each vehicle 50. When external charging is started in S64, the processing in FIG. 8 is performed in parallel to processing in FIG. 13. Thereafter, the process proceeds to S65.

In S65, ECU 150 determines whether or not it has received the charging power command (S56 in FIG. 12) from server 30. Since server 30 does not transmit the charging power command to the earliest vehicle, in S65, determination as NO is made in vehicle 50A and the process proceeds to S67.

In S67, ECU 150 determines whether or not timing of transmission of the end prediction signal has come. In this embodiment, timing of transition from the CP1 period to the CV period (timing t_{A}2 in the first charging pattern shown in FIG. 5 and timing t_{B}4 in the second charging pattern shown in FIG. 6) in the processing in S13 in FIG. 8 is set as the timing of transmission of the end prediction signal.

When it is determined that the timing of transmission of the end prediction signal has come (YES in S67), the process proceeds to S69 after ECU 150 transmits the end prediction signal to server 30 in S68. The end prediction signal is a signal that predicts end of external charging started in S64. When it is determined that timing of transmission of the end prediction signal has not yet come (NO in S67), the process proceeds to S69 without transmission of the end prediction signal.

In S69, ECU 150 determines whether or not charging in the charging pattern selected in S631 or S632 has ended. When charging has not ended (NO in S69), the process returns to S64.

In vehicle 50A, as ECU 150 performs processing in FIG. 8, external charging is carried out in the first charging pattern shown in FIG. 5. The processing in FIG. 8 is performed in parallel to the processing in FIG. 13. During charging period T10 in FIG. 5, external charging with constant electric power P11 is carried out. ECU 150 sets charging power (in this embodiment, electric power P30 shown in FIG. 4) designated by the DR increase signal to electric power P11 in FIG. 5. In the first charging pattern shown in FIG. 5, when timing t_{A}2 of transition from charging period T10 (the CP1 period) to charging period T21 (the CV period) comes, determination as YES is made in S67 in FIG. 13, and vehicle 50A transmits the first end prediction signal to server 30 in S68 in FIG. 13. ECU 150 performs the processing shown in each of FIGS. 8 and 13. As a result of processing in S16 in FIG. 8, transition from charging period T21 to charging period T22 (the CP2 period) in the first charging pattern shown in FIG. 5 is made. When charging ends in S19 in FIG. 8, it is determined that charging has ended (YES in S69) and a series of processing shown in each of FIGS. 8 and 13 ends.

In each of vehicles 50B to 50D, charging periods T31 and T32 immediately after start of charging in the second charging pattern shown in FIG. 6 fall under the overlapping charging period. Therefore, each of vehicles 50B to 50D receives the charging power command from server 30 (S56 in FIG. 12) during charging periods T31 and T32. During charging periods T31 and T32, it is determined that the charging power command has been received (YES in S65 in FIG. 13) and the process proceeds to S66 in FIG. 13. In S66 in FIG. 13, ECU 150 controls charging power during charging periods T31 and T32 in accordance with the charging power command received from server 30. ECU 150 may determine charging power during a period for which it does not receive the charging power command from server 30, based on the second charging pattern stored in storage 153 (FIG. 1). For example, ECU 150 can interpolate charging power between a presently received command and a next received command by calculation based on the second charging pattern. Charging period T32 in FIG. 6 (and the overlapping charging period) ends as charging in the preceding vehicle ends.

As ECU 150 of each of vehicles 50B to 50D performs processing in FIG. 8, charging during charging periods T40, T51, and T52 in the second charging pattern shown in FIG. 6 is carried out. The processing in FIG. 8 is performed in parallel to the processing in FIG. 13. During charging period T40 in FIG. 6, external charging with constant electric power P22 is carried out. Electric power P22 in FIG. 6 corresponds to charging power designated by the DR increase signal (in this embodiment, electric power P30 shown in FIG. 4). In each of vehicles 50B and 50C, when timing t_{B}4 of transition from charging period T40 (the CP1 period) to charging period T51 (the CV period) in the second charging pattern shown in FIG. 6 comes, determination as YES is made in S67 in FIG. 13 and the process proceeds to S68. Vehicles 50B and 50C transmit the second end prediction signal and the third end prediction signal in S68 in FIG. 13, respectively. Vehicle 50D, similarly to vehicles 50B and 50C, may also transmit the end prediction signal to server 30 at timing t_{B}4. Vehicle 50D, however, corresponds to the last vehicle (that is, the vehicle that starts external charging last among vehicles 50A to 50D that constitute the charging group). Therefore, vehicle 50D does not have to transmit the end prediction signal.

In each of vehicles 50B to 50D, ECU 150 performs the processing shown in each of FIGS. 8 and 13. As a result of processing in S16 in FIG. 8, transition from charging period T51 to charging period T52 (the CP2 period) in the second charging pattern shown in FIG. 6 is made. When charging ends in S19 in FIG. 8, it is determined that charging has ended (YES in S69 in FIG. 13) and a series of processing shown in each of FIGS. 8 and 13 ends.

As server 30 performs the processing shown in each of FIGS. 11 and 12 and each of vehicles 50A to 50D performs the processing shown in each of FIGS. 8 and 13, vehicles 50A to 50D carry out relayed charging shown in FIG. 4. According to relayed charging shown in FIG. 4, no charging discontinuity occurs at the time of succession between vehicles, and external charging in vehicles 50A to 50D is continuously carried out. As external charging is carried out without charging discontinuity, more vehicles can participate in DR to gain an incentive.

In the embodiment, controller 31 of server 30 transmits the charging power command to a later vehicle of two vehicles that carry out external charging, so as to keep the sum (that is, total sum electric power) of charging power for external charging simultaneously carried out for the overlapping charging period constant (S56 in FIG. 12). Without being limited as such, server 30 may transmit a command (charging power command) for controlling charging power to keep total sum electric power constant to a preceding vehicle (that is, a vehicle that starts external charging earlier) of two vehicles that carry out external charging for the overlapping charging period, or to each of the two vehicles. Server 30 does not have to transmit the charging power command. Namely, S54 to S56 in the processing in FIG. 12 may be omitted. According to such a configuration that server 30 does not transmit the charging power command as well, the earliest vehicle (for example, vehicle 50A) carries out external charging in the first charging pattern (FIG. 5) and a following vehicle (for example, vehicles 50B to 50D) carries out external charging in the second charging pattern (FIG. 6) so that total sum electric power for the overlapping charging period is more readily kept substantially constant.

The number of vehicles that constitute one charging group is not limited to four but any number may be set. Two vehicles, ten or more vehicles, or one hundred or more vehicles may constitute one charging group.

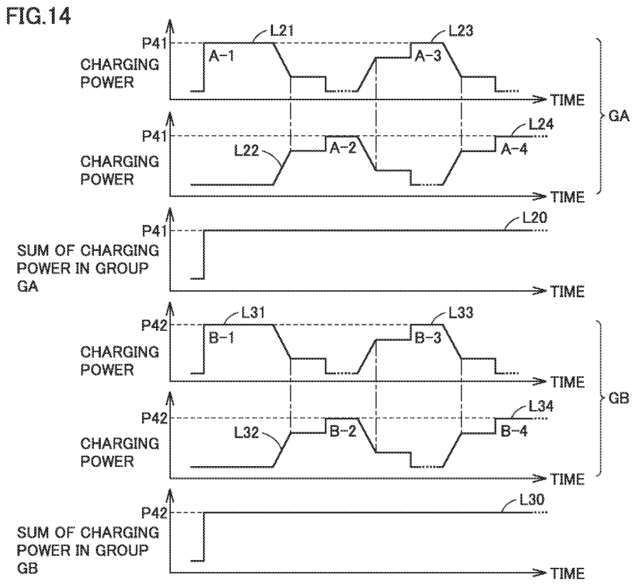

Server 30 may have a plurality of charging groups carry out relayed charging simultaneously in parallel. FIG. 14 is a diagram showing exemplary relayed charging carried out by a plurality of charging groups simultaneously in parallel. In FIG. 14, lines L21 to L24 represent transition of charging power in vehicles A-1 to A-4 that constitute a charging group GA. A line L20 represents the sum of charging power for all vehicles that constitute charging group GA. In FIG. 14, lines L31 to L34 represent transition of charging power in vehicles B-1 to B-4 that constitute a charging group GB. A line L30 represents the sum of charging power for all vehicles that constitute charging group GB.

Referring to FIG. 14, vehicle A-1 carries out external charging in the first charging pattern in which electric power P41 is set as maximum electric power (electric power P11 in FIG. 5). Each vehicle (FIG. 14 showing only vehicles A-2 to A-4) following vehicle A-1 in charging group GA carries out external charging in the second charging pattern in which electric power P41 is set as maximum electric power (electric power P22 in FIG. 6).

Vehicle B-1 carries out external charging in the first charging pattern in which electric power P42 is set as maximum electric power (electric power P11 in FIG. 5). Each vehicle (FIG. 14 showing only vehicles B-2 to B-4) following vehicle B-1 in charging group GB carries out external charging in the second charging pattern in which electric power P42 is set as maximum electric power (electric power P22 in FIG. 6).

As server 30 performs the processing in each of FIGS. 11 and 12 and each vehicle that constitutes charging groups GA and GB performs the processing shown in each of FIGS. 8 and 13, each of charging groups GA and GB carries out relayed charging. Server 30 keeps total sum electric power constant by transmitting the charging power command to at least one of two vehicles that carry out external charging for the overlapping charging period. The sum of charging power for charging group GA is thus maintained at constant electric power P41 and the sum of charging power for charging group GB is maintained at constant electric power P42. Server 30 separately controls the sum of charging power for charging group GA and the sum of charging power for charging group GB. Without being limited as such, server 30 may control each vehicle to keep the total of the sum of charging power for charging group GA and the sum of charging power for charging group GB constant.

The number of vehicles that constitute charging group GA may be equal to or different from the number of vehicles that constitute charging group GB. Timing of start of charging in charging group GA may be identical to or different from timing of start of charging in charging group GB. Electric power P41 and electric power P42 shown in FIG. 14 may be equal to or different from each other. By setting electric power P41 to be lower than electric power P42, charging group GA may be constituted of vehicles that cannot be charged with high charging power and charging group GB may be constituted of vehicles that can be charged with high charging power.

In the embodiment, each vehicle included in the electric power system holds the first charging pattern and the second charging pattern. Without being limited as such, each vehicle included in the electric power system may hold only the first charging pattern and not hold the second charging pattern. Each vehicle may carry out external charging in the first charging pattern while that vehicle alone carries out charging, whereas it may prioritize the charging power command from server 30 over the first charging pattern in carrying out relayed charging. In such an electric power system, during a period which is not the overlapping charging period in relayed charging, each vehicle carries out external charging in the first charging pattern. During the overlapping charging period in relayed charging, a second or subsequent vehicle (that is, each vehicle following the earliest vehicle) carries out external charging in accordance with the charging power command resulting from processing in S54 to S56 in FIG. 12 in order to maintain total sum electric power constant. The charging pattern of the second or subsequent vehicle is thus set to the second charging pattern. According to the configuration, suitable relayed charging can be carried out without adding a new charging pattern (for example, the second charging pattern) to each vehicle.

In the embodiment, the earliest vehicle (vehicle 50A) of four vehicles that constitute a charging group carries out external charging in the first charging pattern (FIG. 5) and other vehicles (vehicles 50B to 50D) carry out external charging in the second charging pattern (FIG. 6). Without being limited as such, all vehicles that constitute a charging group may carry out external charging in the same charging pattern.

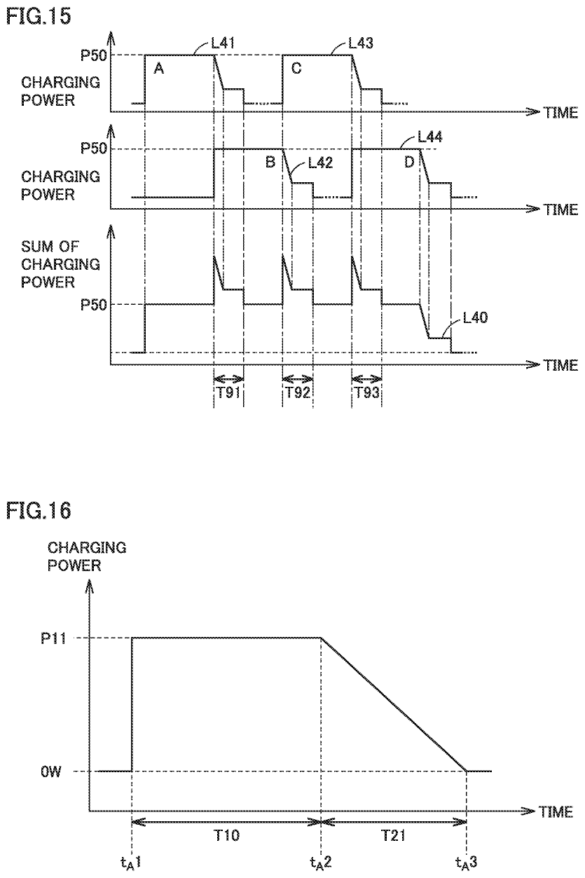

FIG. 15 is a diagram showing exemplary external charging in the first charging pattern (FIG. 5) in each of vehicles 50A to 50D constituting a charging group. In FIG. 15, lines L41 to L44 represent transition of charging power in respective vehicles 50A to 50D. A line L40 represents the sum of charging power in all vehicles (vehicles 50A to 50D) that constitute the charging group. Each of periods T91 to T93 in FIG. 15 corresponds to the overlapping charging period.

Referring to FIG. 15, each of vehicles 50A to 50D carries out external charging in the first charging pattern in which electric power P50 is set as maximum electric power (electric power P11 in FIG. 5). In this example, server 30 does not control total sum electric power during the overlapping charging period. Namely, S54 to S56 in FIG. 12 are not performed. Therefore, total sum electric power during the overlapping charging period is higher than electric power P50. With such a charging method as well, the sum of charging power in the charging group can substantially be constant by shortening the overlapping charging period (periods T91 to T93).

In the embodiment, in a vehicle that carries out external charging in the first charging pattern (FIG. 5), ECU 150 transmits the end prediction signal at timing t_{A}2. Without being limited as such, timing of transmission of the end prediction signal may be set to any timing after timing t_{A}2 and before end of charging (before timing t_{A}4). For example, the end prediction signal may be transmitted at timing t_{A}3.

In the embodiment, in a vehicle that carries out external charging in the second charging pattern (FIG. 6), ECU 150 transmits the end prediction signal at timing t_{B}4. Without being limited as such, timing of transmission of the end prediction signal may be set to any timing after timing t_{B}4 and before end of charging (before timing t_{B}6). For example, the end prediction signal may be transmitted at timing t_{B}5.

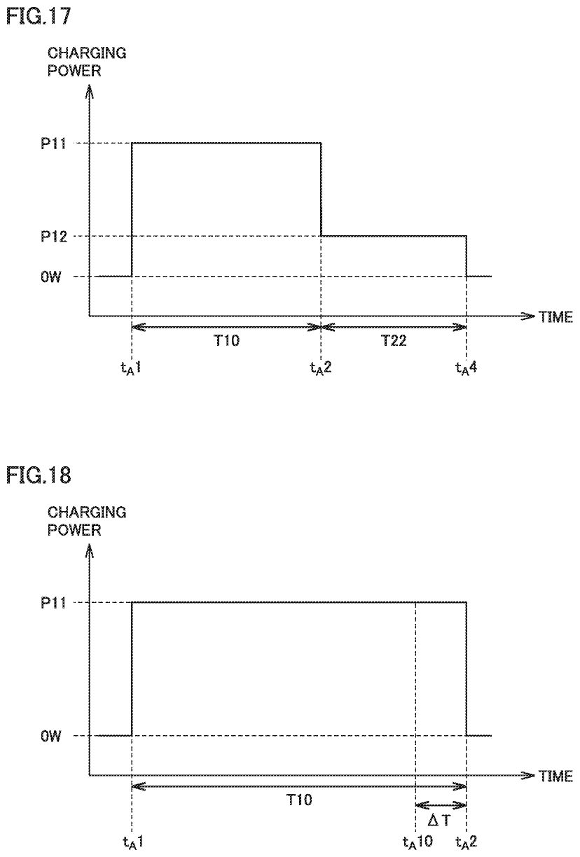

The charging pattern in external charging in each vehicle that constitutes a charging group is not limited to the first charging pattern and the second charging pattern, and can be modified as appropriate. FIG. 16 is a diagram showing a first modification of the first charging pattern. As shown in FIG. 16, a charging pattern from which charging period T22 in the first charging pattern has been excluded may be adopted. FIG. 17 is a diagram showing a second modification of the first charging pattern. As shown in FIG. 17, a charging pattern from which charging period T21 in the first charging pattern has been excluded may be adopted. FIG. 18 is a diagram showing a third modification of the first charging pattern. As shown in FIG. 18, a charging pattern from which charging periods T21 and T22 in the first charging pattern have been excluded may be adopted. In the charging pattern shown in FIG. 18, the end prediction signal may be transmitted at timing t_{A}10 (for example, immediately before end of charging) preceding timing t_{A}2 (charging end timing) by a prescribed time period ΔT.

In VGI system 1 according to the embodiment, at the time of succession between vehicles in relayed charging, the preceding vehicle transmits the end prediction signal to server 30 at timing close to the end of external charging, server 30 transmits a start signal (charging start command) to a later vehicle as being triggered by the end prediction signal, and the later vehicle starts external charging in response to the start signal received from server 30. Without being limited as such, the end prediction signal may function as the charging start command. The preceding vehicle and the later vehicle may communicate with each other (vehicle-to-vehicle communication) and the preceding vehicle may directly transmit the end prediction signal to the later vehicle, not via server 30. The later vehicle may then start external charging at timing of reception of the end prediction signal from the preceding vehicle.

In the embodiment, adjustment of electric power requested in the power market is made by relayed charging (see FIG. 11) when trading of electric power in the power market is done. Without being limited as such, adjustment of electric power requested in DR may be made by relayed charging when an aggregator participates in DR requested by the electric power utility company.

In the embodiment, a DR signal with which an electric utility (for example, an electric power utility company or an aggregator) requests a demand side to balance between supply and demand of electric power is given as an exemplary signal that requests for balancing between supply and demand of electric power. A signal that requests for balancing between supply and demand of electric power, however, is not limited to such a DR signal. For example, a signal with which one demand side (for example, an individual or a company) requests another demand side (for example, an individual or a company) to balance between supply and demand of electric power or a signal (for example, a signal that requests external charging at home) automatically transmitted from a communication apparatus at home to an electrically powered vehicle (or a portable terminal carried by a user) when an amount of power generation in a self-generation facility installed in the user's house (or an amount of electric power stored in the power storage) becomes large may be applicable. A plurality of vehicles in one household may constitute a charging group, and when a signal requesting external charging at home is transmitted to the charging group, the plurality of vehicles that constitute the charging group may carry out relayed charging without discontinuity.

The configuration of the electric power system is not limited to the configuration shown in FIGS. 2 and 3. For example, the electric power utility company may be divided for each business sector. A power generation utility and a power transmission and distribution utility included in the electric power system may belong to companies different from each other. One charging facility may include a plurality of charging cables. The electric power system may determine contribution to power leveling with the use of a charging cable with a metering function, instead of or in addition to the smart meter. The external power supply provided outside the vehicle is not limited to the power grid provided by an electric utility. A household power supply installed in a user's house may be adopted as the external power supply.

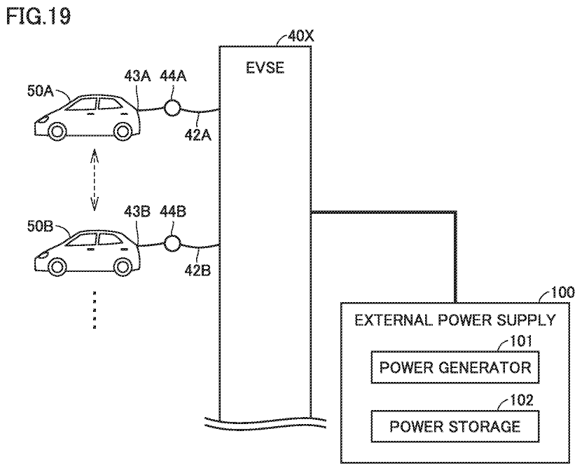

FIG. 19 is a diagram showing a modification of the electric power system shown in FIGS. 2 and 3. Referring to FIG. 19, an external power supply 100 includes a power generator 101 and a power storage 102. For example, a household power supply is adopted as external power supply 100. Power generator 101 generates power, for example, through wind power generation or photovoltaic generation. Electric power generated by power generator 101 is stored in power storage 102. Electric power stored in power storage 102 is supplied, for example, to a home switchboard (not shown) and EVSE 40X installed at home.

EVSE 40X includes a plurality of charging cables (FIG. 19 showing only charging cables 42A and 42B). Charging cables 42A and 42B include connectors 43A and 43B at respective tip ends and includes wattmeters 44A and 44B in the middle of the cables, respectively. A plurality of vehicles (FIG. 19 showing only vehicles 50A and 50B) are electrically connected to EVSE 40X. EVSE 40X is electrically connected to vehicle 50A through charging cable 42A and electrically connected to vehicle 50B through charging cable 42B. Wattmeters 44A and 44B measure an amount of electric power supplied from EVSE 40X to vehicles 50A and 50B, respectively. Each vehicle electrically connected to EVSE 40X can carry out relayed charging, for example, by transmitting the end prediction signal to a next vehicle through vehicle-to-vehicle communication.

A configuration of the vehicle included in the electric power system is not limited to the configuration shown in FIG. 3. For example, it is not essential that the vehicle includes a power feeder that feeds power to the outside of the vehicle. A charger capable of only external charging may be adopted instead of charger-discharger 120 in the configuration shown in FIG. 1. In the embodiment, ECU 150 of each vehicle 50 holds the charging pattern and ECU 150 of each vehicle 50 controls charging (for example, the processing in FIG. 8) to thereby carry out relayed charging. Without being limited as such, controller 31 of server 30 may remotely control each vehicle through wireless communication to have a plurality of vehicles carry out relayed charging. Controller 31 may function as the “first charging controller” and the “second charging controller” according to the present disclosure.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. An electric power system comprising:
a first vehicle including an externally chargeable first power storage;
a second vehicle including an externally chargeable second power storage; and
an external power supply that supplies electric power to each of the first vehicle and the second vehicle, wherein
the first vehicle starts external charging of the first power storage with electric power supplied from the external power supply while the first vehicle is electrically connected to the external power supply, and
when the second vehicle receives a signal predicting end of external charging of the first power storage while the second vehicle is electrically connected to the external power supply, the second vehicle starts external charging of the second power storage with electric power supplied from the external power supply before end of external charging started in the first vehicle.

2. The electric power system according to claim 1, further comprising:
an electric power controller that controls at least one of the first vehicle and the second vehicle so as to keep a sum of charging power for the first power storage and charging power for the second power storage at prescribed electric power during a period for which both of external charging of the first power storage in the first vehicle and external charging of the second power storage in the second vehicle are simultaneously carried out.

3. The electric power system according to claim 1, further comprising a first charging controller that carries out external charging of the first power storage in a prescribed first charging pattern, wherein
the prescribed first charging pattern includes a first charging period and a second charging period following the first charging period,
the first charging period is a period during which external charging with first electric power is carried out,
the second charging period is a period during which external charging with electric power lower than the first electric power is carried out, and
the second vehicle receives a signal predicting end of external charging of the first power storage at end of the first charging period or during the second charging period.

4. The electric power system according to claim 1, further comprising a first charging controller that carries out external charging of the first power storage in a prescribed first charging pattern, wherein
the prescribed first charging pattern includes a first charging period and a second charging period following the first charging period,
the first charging period is a period during which external charging with first electric power is carried out,
the second charging period is a period during which external charging with electric power lower than the first electric power is carried out,
the second vehicle receives a signal predicting end of external charging of the first power storage at end of the first charging period, and
the electric power system further comprises an electric power controller that controls at least one of the first vehicle and the second vehicle so as to keep a sum of charging power for the first power storage and charging power for the second power storage at the first electric power during a period for which both of external charging of the first power storage in the first vehicle and external charging of the second power storage in the second vehicle are simultaneously carried out.

5. The electric power system according to claim 3, wherein
when an SOC of the first power storage becomes equal to or larger than a prescribed SOC value while external charging of the first power storage is being carried out in the prescribed first charging pattern, the first charging controller quits the first charging period and makes transition to the second charging period.

6. The electric power system according to claim 5, wherein
the first charging controller accepts input of an SOC value by a user and sets the prescribed SOC value based on the SOC value input by the user.

7. The electric power system according to claim 5, wherein
the first charging controller sets the prescribed SOC value based on an amount of electric power estimated to be used in next travel.

8. The electric power system according to claim 1, further comprising a second charging controller that carries out external charging of the second power storage in a prescribed second charging pattern, wherein
the prescribed second charging pattern includes a third charging period immediately after start of charging and a fourth charging period following the third charging period,
the fourth charging period is a period during which external charging with second electric power is carried out, and
the third charging period is a period during which external charging with electric power lower than the second electric power is carried out.

9. The electric power system according to claim 1, further comprising a server that issues to the first vehicle, a request for increase in demand for electric power supplied by the external power supply, wherein
the first vehicle starts external charging of the first power storage with electric power supplied from the external power supply in response to the request from the server,
the external power supply is a power grid provided by an electric utility,
the power grid supplies electric power to a plurality of charging facilities, and
each of the first vehicle and the second vehicle is electrically connected to the power grid through any of the plurality of charging facilities.

10. A vehicle adapted to a charging method in which a plurality of vehicles carry out external charging successively in a relayed manner by receiving supply of electric power from a common external power supply, the vehicle comprising:
an externally chargeable power storage;
a charging controller that controls external charging of the power storage; and
a communication controller that controls communication with outside of the vehicle, wherein
the vehicle is defined as a target vehicle,
another vehicle that is carrying out external charging with the charging method is defined as a preceding vehicle,
when the charging controller receives a start signal that predicts end of external charging in the preceding vehicle while the target vehicle is electrically connected to the common external power supply, the charging controller starts external charging of the power storage with electric power supplied from the common external power supply before end of external charging in the preceding vehicle.
